(19) United States
(12) Patent Application Publication
(10) Pub. No.: US 2024/0114470 A1
(43) Pub. Date: Apr. 4, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/539,309

(22) Filed: Dec. 14, 2023

Related U.S. Application Data
(63) Continuation of application No. PCT/CN2022/100952, filed on Jun. 24, 2022.

(30) Foreign Application Priority Data
Jun. 28, 2021 (CN) 202110719734.5

(51) Int. Cl. H04W 56/00; H04J 11/00; H04W 76/10

(52) U.S. Cl. CPC H04W 56/0015; H04J 11/0069; H04W 76/10; H04W 92/18

(57) ABSTRACT

The present application discloses a method and a device for wireless communications, including: receiving a first signal, the first signal comprising a first message; and determining a synchronization reference according to at least whether the first message is transmitted via a direct path; the first message indicating a first sidelink frequency list, the first sidelink frequency list comprising a first frequency, which is used for sidelink communication; and receiving a first synchronization signal from the synchronization reference determined; and transmitting a second synchronization signal; a reception timing for the first synchronization signal being used to determine a transmission timing of the second synchronization signal. By receiving the first message and first synchronization signal, the present application can determine the synchronization reference correctly.

### CROSS REFERENCE TO RELATED APPLICATIONS

This application is the continuation of an international patent application No. PCT/CN2022/118880, filed on Jun. 24, 2022, and claims the priority benefit of Chinese Patent Application No. 202110719734.5, filed on Jun. 28, 2021, the full disclosure of which is incorporated herein by reference.

### BACKGROUND

### Technical Field

The present application relates to transmission methods and devices in wireless communication systems, and in particular to a method and device in wireless communications for reducing traffic interruption, enhancing traffic continuity, improving the reliability and security.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non Terrestrial Network (NTN) and Terrestrial Network (TN), Dual connectivity system, or combined, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE's connection with the network can be achieved directly or by relaying.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

The 3GPP standardization organization has worked on 5G standardization to formulate a series of specifications such as 38.304, 38.211, and 38.213, of which the details can refer to:
https://www.3gpp.org/ftp/Specs/archive/38_series/38.304/38304-g40.zip
https://www.3gpp.org/ftp/Specs/archive/38_series/38.211/38211-g50.zip
https://www.3gpp.org/ftp/Specs/archive/38_series/38.213/38213-g50.zip

### SUMMARY

The relay can be used in various communication scenarios, for instance, when a UE is not within coverage of a cell, it can be accessible to the network via the relay, where the relay node can be another UE. The relay generally includes L3 relay and L2 relay, both of which provide the service of access to the network for a remote UE via a relay node. The L3 relay is transparent to the access network, namely, a remote UE only establishes connection with the core network, so the access network cannot recognize whether data is from a remote node or a relay node; while in the L2 relay, a remote node is RRC connected with an access network, where the access network can manage the remote node, and a radio bearer can be established between the access network and the remote node. The remote node can receive broadcast messages and unicast messages from the network through the relay node. And these messages can be used to determine a synchronization reference. The synchronization reference is an essential feature of sidelink communications, which enables both sides of the communications to get relatively synchronized. Obtaining the timing information helps to receive signals and avoid blind detection. Therefore, each UE in sidelink communications shall perform the procedure of determining a synchronization reference. The determination of the synchronization reference is closely related to the transmission of synchronization signals. The concept of synchronization is involved only when there are at least two nodes, so in addition to the reception of synchronization signals the synchronization also involves the transmission of synchronization signals. These two aspects are complementary. The determination of synchronization reference involves many factors, including the synchronization priority order indicated by the network, the presence in coverage and the type of the synchronization reference. A new problem may emerge in relay-supporting sidelink communications, namely, messages are not received directly from the network but by means of forwarding of a relay, which means that there is no direct linkage between the remote node and the network, which in some cases might lead to a result that the remote node mistakenly configures a cell that has generated these messages as the synchronization reference, which causes trouble in terms of synchronization and then influences the sidelink communications, and, even worse, will result in communication failure due to out of sync.

To address the above problem, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first signal, the first signal comprising a first message; and determining a synchronization reference according to at least whether the first message is transmitted via a direct path; the first message indicating a first sidelink frequency list, the first sidelink frequency list comprising a first frequency, the first frequency being used for sidelink communication; and receiving a first synchronization signal from the synchronization reference determined; and
transmitting a second synchronization signal; a reception timing for the first synchronization signal being used to determine a transmission timing of the second synchronization signal.

In one embodiment, a problem to be solved in the present application includes: how to determine a synchronization reference for a node that performs sidelink communications, particularly a remote node, in scenarios where relay is used.

In one embodiment, an advantage of the above method includes: for determination of a synchronization reference, the method proposed by the present application takes into account how a specific message having been received is transmitted, that is, whether to be transmitted via a direct path, so that different methods can be adopted based on different situations; particularly when the message received is not transmitted via a direct path, this method can prevent an invalid or less applicable node from being determined as a synchronization reference. Therefore, the reliability is improved and the normal sidelink communications is guaranteed.

Specifically, according to one aspect of the present application, performing cell search to determine in coverage of at least a first cell;

herein, the first message is not transmitted via a direct path, and a synchronization priority order indicated by the first message is a base station, and the synchronization reference determined is a synchronization reference User Equipment (UE).

Specifically, according to one aspect of the present application, receiving a first sidelink master information block (MIB), the first sidelink MIB indicating whether in coverage; a synchronization signal identity corresponding to the first synchronization signal is a first identity; the first sidelink MIB and the first identity are used to determine a sequence generating the second synchronization signal;

herein, the first message is used for indicating transmission timing information of the second synchronization signal, and a transmission timing of the second synchronization signal is different from a transmission timing of the first synchronization signal.

Specifically, according to one aspect of the present application, failing to detect a cell on a first frequency; the first message being not transmitted via a direct path; a transmitter of the first synchronization signal being determined as a synchronization reference; the synchronization reference determined being a synchronization reference UE; and a synchronization priority order indicated by the first message being a base station;

herein, the first message comprises first transmission timing information and second transmission timing information; the first transmission timing information is used to indicate transmission timing information of the second synchronization signal; the second transmission timing information is used to determine a sidelink synchronization signal identity of the second synchronization signal; and the second transmission timing information is related to Global Navigation Satellite System (GNSS).

Specifically, according to one aspect of the present application, performing cell search to determine not in coverage of a first cell but in coverage of a second cell; the first cell is a generator of the first message; and the first cell is a Primary Cell (PCell) or a serving cell of the first node; the second cell is a cell other than the PCell or the serving cell of the first node; the first cell and the second cell are both on the first frequency; the first frequency is a primary frequency;

herein, the first message is not transmitted via a direct path, and a synchronization priority order indicated by the first message is a base station, and the synchronization reference determined is the second cell.

Specifically, according to one aspect of the present application, performing cell search to determine in coverage of the first frequency; the first frequency is a frequency other than a primary frequency or a secondary frequency;

herein, the first message is not transmitted via a direct path, and the synchronization reference determined is the first frequency.

Specifically, according to one aspect of the present application, transmitting a second sidelink MIB; the second sidelink MIB being transmitted along with the second synchronization signal; whether the first message is transmitted via a direct path being used to determine whether the second sidelink MIB indicates in coverage;

herein, that whether the first message is transmitted via a direct path is used to determine whether the second sidelink MIB indicates in coverage comprises that:

when the first node is in coverage at the first frequency and the first message is not transmitted via a direct path, the second sidelink MIB does not indicate in coverage; when the first node is in coverage at the first frequency, and the first message is transmitted via a direct path, the second sidelink MIB indicates in coverage.

Specifically, according to one aspect of the present application, transmitting a second sidelink MIB; the second sidelink MIB being transmitted along with the second synchronization signal;

herein, GNSS is determined as a synchronization reference; the first message comprises second transmission timing information; and the second transmission timing information is used to indicate transmission timing information of the second synchronization signal; whether the first message comprises the second transmission timing information is used to determine whether the second sidelink MIB indicates in coverage.

Specifically, according to one aspect of the present application, the first node is a UE.

Specifically, according to one aspect of the present application, the first node is a terminal of Internet of Things (IoT).

Specifically, according to one aspect of the present application, the first node is a relay.

Specifically, according to one aspect of the present application, the first node is a vehicle-mounted terminal.

Specifically, according to one aspect of the present application, the first node is an aircraft.

The present application provides a method in a first node for wireless communications, comprising:
receiving a second signal, the second signal comprising a first message; the first message indicating a first sidelink frequency list, the first sidelink frequency list comprising a first frequency, the first frequency being used for sidelink communication;
transmitting a first signal and a first synchronization signal, the first signal comprising the first message; a receiver of the first signal, determining a synchronization reference according to at least whether the first message is transmitted via a direct path; and
transmitting a second synchronization signal; a reception timing of the first synchronization signal is used to determine a transmission timing of the second synchronization signal.

Specifically, according to one aspect of the present application, transmitting a first sidelink master information block (MIB), the first sidelink MIB indicating whether in coverage; a synchronization signal identity corresponding to the first synchronization signal is a first identity; the first sidelink MIB and the first identity are used to determine a sequence generating the second synchronization signal;

herein, the first message is used for indicating transmission timing information of the second synchronization signal, and a transmission timing of the second synchronization signal is different from a transmission timing of the first synchronization signal.

Specifically, according to one aspect of the present application, receiving a second synchronization signal and a second sidelink MIB, the second node providing relay service to a transmitter of the second synchronization signal and the second sidelink MIB; when a first condition set is satisfied, the transmitter of the second synchronization signal and the second sidelink MIB is not determined as a synchronization reference; a synchronization priority order indicated by the first message is a base station.

Specifically, according to one aspect of the present application, the second node is a UE.

Specifically, according to one aspect of the present application, the second node is a terminal of Internet of Things (IoT).

Specifically, according to one aspect of the present application, the second node is a relay.

Specifically, according to one aspect of the present application, the second node is a vehicle-mounted terminal.

Specifically, according to one aspect of the present application, the second node is an aircraft.

The present application provides a first node for wireless communications, comprising:
a first receiver, which receives a first signal, the first signal comprising a first message; and determining a synchronization reference according to at least whether the first message is transmitted via a direct path; the first message indicating a first sidelink frequency list, the first sidelink frequency list comprising a first frequency, the first frequency being used for sidelink communication; and receiving a first synchronization signal from the synchronization reference determined; and
a first transmitter, which transmits a second synchronization signal; a reception timing for the first synchronization signal being used to determine a transmission timing of the second synchronization signal.

The present application provides a second node for wireless communications, comprising:
a second receiver, which receives a second signal, the second signal comprising a first message; the first message indicating a first sidelink frequency list, the first sidelink frequency list comprising a first frequency, the first frequency being used for sidelink communication;
a second transmitter, which transmits a first signal and a first synchronization signal, the first signal comprising the first message; a receiver of the first signal, determining a synchronization reference according to at least whether the first message is transmitted via a direct path;
a receiver of the first signal, which transmits a second synchronization signal; a reception timing of the first synchronization signal is used to determine a transmission timing of the second synchronization signal.

In one embodiment, compared with the prior art, the present application is advantageous in the following aspects:

It avoids the situation in which the system message or configuration message is received from the network not by means of direct-path transmission and the generator of these messages are mistakenly determined as the synchronization reference.

In sidelink communication scenarios where relay exists, an optimal or better synchronization reference can be determined in an effective manner, thereby ensuring the normal conduction of communications.

It helps to choose a proper synchronization reference and rule out synchronization reference sources that are invalid in all kinds of scenarios where optional synchronization references include UE, GNSS or the frequency that sidelink communication is concerned with.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first synchronization signal, receiving a first signal and transmitting a second synchronization signal according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to the present application.

FIG. 5 illustrates a flowchart of transmission according to one embodiment of the present application.

FIG. 6 illustrates a schematic diagram of a sidelink synchronization signal block? according to one embodiment of the present application.

FIG. 7 illustrates a schematic diagram of a transmission timing according to one embodiment of the present application.

FIG. 8 illustrates a schematic diagram of a protocol stack of relay communications according to one embodiment of the present application.

FIG. 9 illustrates a schematic diagram of a reception timing for a first synchronization signal being used to determine a transmission timing of a second synchronization signal according to one embodiment of the present application.

FIG. 10 illustrates a schematic diagram of a first sidelink MIB and a first identity being used to determine a sequence generating a second synchronization signal according to one embodiment of the present application.

FIG. 11 illustrates a schematic diagram of a first message being used to indicate transmission timing information of a second synchronization signal according to one embodiment of the present application.

FIG. 12 illustrates a schematic diagram of second transmission timing information being used to determine a sidelink synchronization signal identity of a second synchronization signal according to one embodiment of the present application.

FIG. 13 illustrates a schematic diagram of whether a first message comprises second transmission timing information being used to determine whether a second sidelink MIB indicates in coverage according to one embodiment of the present application.

FIG. 14 illustrates a structure block diagram of a processing device in a first node according to one embodiment of the present application.

FIG. 15 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of receiving a first synchronization signal, receiving a first signal and transmitting a second synchronization signal according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first synchronization signal in step 101; and receives a first signal in step 102; and transmits a second synchronization signal in step 103;

herein, the first signal comprises a first message; determining a synchronization reference according to at least whether the first message is transmitted via a direct path; the first message indicating a first sidelink frequency list, the first sidelink frequency list comprising a first frequency, the first frequency being used for sidelink communication; a reception timing for the first synchronization signal being used to determine a transmission timing of the second synchronization signal.

In one embodiment, the first node is a User Equipment (UE).

In one embodiment, a direct path refers to a UE-to-Network (U2N) transmission path, so transmitting through the direct path means that data is transmitted without being relayed between a remote UE and the network in U2N transmission.

In one subembodiment, the data comprises higher-layer data and signaling

In one subembodiment, the data comprises a bit string or a bit block.

In one embodiment, an indirect path refers to a UE-to-Network (U2N) transmission path, so transmitting through the indirect path means that data is forwarded by a U2N relay UE between a remote UE and the network in U2N transmission.

In one subembodiment, the data comprises higher-layer data and signaling

In one subembodiment, the data comprises a bit string or a bit block.

In one embodiment, a U2N relay UE refers to a UE providing the function of supporting connections between a U2N remote UE and the network.

In one embodiment, a U2N remote UE refers to a UE that needs to be relayed by a U2N relay UE in communications with the network.

In one embodiment, a U2N remote UE refers to a UE that needs to be relayed by a U2N relay UE in communications with the network.

In one embodiment, a U2N remote UE refers to a UE in communications with the network that supports relaying traffics.

In one embodiment, a U2N relay is a U2N relay UE.

In one embodiment, when transmitting to and receiving from the network unicast traffics, the U2N relay and the U2N remote node are both in RRC connected state.

In one embodiment, when the U2N remote UE is in RRC Idle state or RRC Inactive state, the U2N relay UE can be in any RRC state, i.e., RRC Connected state, RRC Idle state or RRC Inactive state.

In one embodiment, not transmitting through a direct path is equivalent to transmitting through an indirect path

In one embodiment, not transmitting through a direct path includes transmitting via a relay.

In one embodiment, transmitting through a direct path includes not transmitting via a relay.

In one embodiment, transmitting through a direct path includes not forwarding via a relay.

In one embodiment, the U2N relay UE is a UE providing the functionality of supporting connectivity to the network for the U2N remote UE.

In one subembodiment, the U2N relay UE is a UE.

In one subembodiment, the U2N relay UE provides the U2N remote UE with the service of relay to the network.

In one embodiment, the U2N remote UE is a UE in communication with the network via the U2N relay UE.

In one embodiment, a UE with capabilities of NR sidelink communications and transmitting SLS S/PSB CH, when transmitting NR sidelink communications, shall transmit sidelink Synchronization Signal Blocks (SSB), including transmitting a Sidelink synchronization Signal (SLSS) and transmitting a MasterinformationBlockSidelink on the frequency of NR sidelink communications, provided that a condition for NR sidelink communication operation is satisfied and any condition in a first transmission condition set is satisfied.

In one subembodiment, the first transmission condition set comprises a first transmission condition, the first transmission condition being: in coverage of the frequency of NR sidelink communications and selecting Global Navigation Satellite Systems (GNSS) or a cell as a synchronization reference.

In one subembodiment, the first transmission condition set comprises a second transmission condition, the second transmission condition being: out of coverage of the frequency of NR sidelink communications with the frequency for transmitting NR sidelink communications being comprised by an RRCReconfiguration message or a SIB12, and selecting GNSS or a cell as a synchronization reference, and staying in RRC Connected state, with networkControlledSyncTx configured to “on”.

In one subembodiment, the first transmission condition set comprises a third transmission condition, the third transmission condition being: out of coverage of frequency of NR sidelink communications with the frequency for transmitting NR sidelink communications being comprised by an RRCReconfiguration message or a SIB12, and selecting GNSS or a cell as a synchronization reference, with networkControlledSyncTx not configured and syncTxThreshIC configured, where a Reference Signal Receiving Power (RSRP) measured of a reference cell of NR sidelink communications is lower than the syncTxThreshlC.

In one subembodiment, the first transmission condition set comprises a fourth transmission condition, the fourth transmission condition being: the first transmission condition not being satisfied and the second transmission condition not being satisfied and the third transmission condition not being satisfied, with syncTxThreshOoC being configured for the frequency of NR sidelink communications, being not in sync with GNSS directly, choosing no synchronization reference UE or a measurement result of a PSBCH-RSRP of a chosen synchronization reference UE being lower than the syncTxThreshOoC.

In one subembodiment, the first transmission condition set comprises a fifth transmission condition, the fifth transmission condition being: the first transmission condition not being satisfied and the second transmission condition not being satisfied and the third transmission condition not being satisfied, and choosing GNSS as a synchronization reference source for the frequency of NR sidelink communications.

In one subembodiment, the first transmission condition set comprises: a way of transmission in communication with the network being changed from indirect-path transmission to direct-path transmission.

In one subembodiment, the first transmission condition set comprises: a way of transmission in communication with the network being changed from direct-path transmission to indirect-path transmission.

In one subembodiment, the first transmission condition set comprises: being a U2N relay UE.

In one embodiment, a serving cell refers to a cell that the UE is camped on. Performing cell search includes that the UE searches for a suitable cell for a selected Public Land Mobile Network (PLMN) or Stand-alone Non-Public Network (SNPN), selects the suitable cell to provide available services, and monitors a control channel of the suitable cell, where the whole procedure is defined to be camped on the cell; in other words, relative to this UE, the cell being camped on is seen as a serving cell of the UE. Being camped on a cell in either RRC Idle state or RRC Inactive state is advantageous in the following aspects: enabling the UE to receive system information from a PLMN or an SNPN; after registration, if a UE hopes to establish an RRC connection or resume a suspended RRC connection, the UE can perform an initial access on a control channel of the camped cell to achieve such purpose; the network can page the UE; so that the UE can receive notifications from the Earthquake and Tsunami Warning System (ETWS) and the Commercial Mobile Alert System (CMAS).

In one embodiment, for a UE in RRC connected state without being configured with carrier aggregation/dual connectivity (CA/DC), there is only one serving cell that comprises a primary cell. For a UE in RRC connected state that is configured with carrier aggregation/dual connectivity (CA/DC), a serving cell is used for indicating a cell set comprising a Special Cell (SpCell) and all secondary cells. A Primary Cell is a cell in a Master Cell Group (MCG), i.e., an MCG cell, working on the primary frequency, and the UE performs an initial connection establishment procedure or initiates a connection re-establishment on the Primary Cell. For dual connectivity (DC) operation, a special cell refers to a Primary Cell (PCell) in an MCG or a Primary SCG Cell (PSCell) in a Secondary Cell Group (SCG); otherwise, the special cell refers to a PCell.

In one embodiment, working frequency of a Secondary Cell (SCell) is secondary frequency.

In one embodiment, separate contents in information elements (IEs) are called fields.

In one embodiment, Multi-Radio Dual Connectivity (MR-DC) refers to dual connectivity with an E-UTRA node and an NR node, or with two NR nodes.

In one embodiment, in MR-DC, a radio access node providing a control plane connection to the core network is a master node, where the master node can be a master eNB, a master ng-eNB or a master gNB.

In one embodiment, an MCG refers to a group of serving cells associated with a master node in MR-DC, including a SpCell, and optionally, one or multiple SCells.

In one embodiment, a PCell is a SpCell of an MCG.

In one embodiment, a PSCell is a SpCell of an SCG.

In one embodiment, in MR-DC, a radio access node not providing a control plane connection to the core network but providing extra resources for the UE is a secondary node. The secondary node can be an en-gNB, a secondary ng-eNB or a secondary gNB.

In one embodiment, in MR-DC, a group of serving cells associated with a secondary node is a secondary cell group (SCG), including a SpCell and, optionally, one or multiple SCells.

In one embodiment, an Access Stratum (AS) functionality that enables Vehicle-to Everything (V2X) communications defined in 3GPP TS 23.285 is V2X sidelink communication, where the V2X sidelink communication occurs between nearby UEs, using E-UTRA techniques but not traversing network nodes.

In one embodiment, an Access Stratum (AS) functionality that at least enables Vehicle-to Everything (V2X) communications defined in 3GPP TS 23.287 is NR sidelink communication, where the NR sidelink communication occurs between two or more nearby UEs, using NR technology but not traversing network nodes.

In one embodiment, not being or not located in coverage is equivalent to being out of coverage.

In one embodiment, being in coverage is equivalent to being covered.

In one embodiment, being out of coverage is equivalent to being uncovered.

In one embodiment, the first node is a U2N remote node.

In one embodiment, the first signal is a physical layer signal.

In one embodiment, the first signal is transmitted via sidelink.

In one embodiment, the first signal is transmitted using resources in a sidelink resource pool.

In one embodiment, a transmission timing of the first signal depends on an SLSS signal.

In one embodiment, a transmission timing of the first signal depends on an SL-SSB signal.

In one embodiment, a transmission timing of the first signal depends on a synchronization reference.

In one embodiment, a physical channel occupied by the first signal includes a physical sidelink shared channel (PSSCH).

In one embodiment, a physical channel occupied by the first signal includes a physical sidelink control channel (PSCCH).

In one embodiment, the first signal is a downlink signal.

In one embodiment, the first signal is not transmitted via sidelink.

In one embodiment, a physical channel occupied by the first signal includes a physical downlink shared channel (PDSCH).

In one embodiment, a physical channel occupied by the first signal includes a physical downlink control channel (PDCCH).

In one embodiment, a transmission timing of the first signal depends on an SSB.

In one embodiment, a transmission timing of the first signal depends on a downlink synchronization signal.

In one embodiment, the first signal is associated with an SSB.

In one embodiment, the first signal carries the first message.

In one embodiment, the first signal bears the first message.

In one embodiment, the first signal comprises all fields of the first message.

In one embodiment, the first signal comprises at least one field of the first message.

In one embodiment, the first message is forwarded to the first node via a PC5-RRC container.

In one embodiment, the first message is an RRC message.

In one embodiment, the first message comprises a system message.

In one embodiment, the first message comprises a System Information Block (SIB).

In one embodiment, the first message comprises a SIB12.

In one embodiment, the first message is a SIB12.

In one embodiment, the first message comprises at least part of fields of a SIB12.

In one embodiment, the first message comprises or only comprises a RRCReconfiguration.

In one embodiment, the first message comprises or only comprises a SIB12.

In one embodiment, the first message is transmitted in a broadcast way.

In one embodiment, the first message is transmitted in a unicast way.

In one embodiment, a generator of the first message is a cell.

In one embodiment, a generator of the first message is a base station.

In one embodiment, the first message is transmitted via a Uu interface.

In one embodiment, the first sidelink frequency list indicates frequency/frequencies for sidelink communications, the first sidelink frequency list comprising at least one frequency.

In one embodiment, the first sidelink frequency list is a sl-FreqInfoToAddModList.

In one embodiment, a sl-ConfigDedicatedNR field in the first message comprises the first sidelink frequency list.

In one embodiment, a sl-ConfigCommonNR field in the first message comprises the first sidelink frequency list.

In one embodiment, the first frequency is a concerned frequency.

In one embodiment, the first frequency is a frequency the first node uses for NR sidelink communications.

In one embodiment, the first frequency is a frequency the first node intends or expects to use for NR sidelink communications.

In one embodiment, the first frequency is a frequency the first node is using for NR sidelink communications.

In one embodiment, the first frequency is a frequency the first node is going to use for NR sidelink communications.

In one embodiment, the first frequency is a frequency the first node determines to be used when performing NR sidelink communications.

In one embodiment, the first frequency is a frequency at which the first node performs NR sidelink communications.

In one embodiment, the first synchronization signal is an SLSS.

In one embodiment, the S-SS/PSBCH block is an SSB.

In one embodiment, the S-SS/PSBCH block is an SL-SSB.

In one embodiment, the S-SS is SLSS.

In one subembodiment, the SLSS include a Sidelink-Primary Synchronization Signal (S-PSS) and a Sidelink-Secondary Synchronization Signal (S-SSS).

In one embodiment, the SLSS include a Sidelink-Primary Synchronization Signal (S-PSS) and a Sidelink-Secondary Synchronization Signal (S-SSS).

In one embodiment, SL refers to sidelink.

In one embodiment, a UE performs a S-SS/PSBCH block-based synchronization procedure by receiving the following sidelink synchronization signals (SLSS): a Sidelink-Primary Synchronization Signal (S-PSS) and a

Sidelink-Secondary Synchronization Signal (S-SSS).

In one embodiment, in time domain, for a normal cyclic prefix, one S-SS/PSBCH block occupies 13 OFDM symbols; for an extended cyclic prefix, one S-SS/PSBCH block occupies 11 OFDM symbols.

In one embodiment, a S-SS/PSBCH comprises an S-PSS, an S-SSS and a PSBCH.

In one subembodiment, the S-SS/PSBCH also comprises a DM-RS associated with a PSBCH.

In one embodiment, a S-SS/PSBCH is transmitted using an antenna port 4000.

In one embodiment, SLSS have 672 unique physical layer sidelink identities, given by the following formula:

N_{ID}^{SL}=N_{ID,1}^{SL}+336N_{ID,2}^{SL}

where N_{ID,1}^{SL} has a value being an integer range from 0 to 335, and N_{ID,2}^{SL} has a value of either 0 or 1; the 672 unique physical layer sidelink identities can uniquely determine a sequence for generating an S-PSS and a sequence for generating an S-SSS by means of a pre-defined formula.

In one embodiment, the 672 unique physical layer sidelink identities are divided into two groups, respectively identified by id_net and id_oon, where the id_net comprises the physical layer sidelink identities of N_{ID}^{SL}=0,1, . . . ,335, and the id_oon comprises the physical layer sidelink identities of N_{ID}^{SL}=336,337, . . . ,671.

In one embodiment, the identities comprised by the id_net group among the 672 unique physical layer sidelink identities indicate presence in coverage.

In one embodiment, the identities comprised by the id_oon group among the 672 unique physical layer sidelink identities indicate presence not in coverage.

In one embodiment, a parameter initial value of DMRS of a physical sidelink broadcast channel (PSBCH) is an identity of the S-SS, i.e., N_{ID}^{SL}; the identity of the S-SS is one of the 672 unique physical layer sidelink identities.

In one embodiment, a length of a sequence for generating the Sidelink-Primary Synchronization Signal (S-PSS) is 127.

In one embodiment, a length of a sequence for generating the Sidelink-Secondary Synchronization Signal (S-SSS) is 127.

In one embodiment, any identity among the 672 unique physical layer sidelink identities is identified as a SLSS ID.

In one embodiment, any identity among the 672 unique physical layer sidelink identities is identified as an SLSS ID.

In one embodiment, a SLSS ID is any identity among the 672 unique physical layer sidelink identities.

In one embodiment, there exists one-to-one correspondence relationship between sidelink synchronization signals and sidelink synchronization signal identities; a sidelink synchronization signal identity can uniquely determine a sidelink synchronization signal; reception of a sidelink synchronization signal can uniquely determine a corresponding sidelink synchronization signal identity.

In one embodiment, a SLSS ID is the sidelink synchronization signal identity.

In one embodiment, any identity among the 672 unique physical layer sidelink identities is a sidelink synchronization signal identity.

In one embodiment, the second synchronization signal is an SLSS.

In one embodiment, the second synchronization signal is a sidelink synchronization signal.

In one embodiment, the first synchronization signal and the second synchronization signal are generated by

a same sequence.

In one embodiment, the first synchronization signal and the second synchronization signal are generated by different sequences.

In one embodiment, a sidelink synchronization signal identity corresponding to the first synchronization signal is identical to a sidelink synchronization signal identity corresponding to the second synchronization signal.

In one embodiment, a sidelink synchronization signal identity corresponding to the first synchronization signal is different from a sidelink synchronization signal identity corresponding to the second synchronization signal.

In one embodiment, the sentence “receiving a first synchronization signal from the synchronization reference determined” includes a meaning that: the action of determining a synchronization reference is performed before the action of receiving the first synchronization signal.

In one embodiment, the sentence “receiving a first synchronization signal from the synchronization reference determined” includes a meaning that: the action of determining a synchronization reference is performed after the action of receiving the first synchronization signal.

In one embodiment, the sentence “receiving a first synchronization signal from the synchronization reference determined” includes a meaning that: the action of determining a synchronization reference and the action of receiving the first synchronization signal are mutually independent temporally.

In one embodiment, the sentence “receiving a first synchronization signal from the synchronization reference determined” includes a meaning that: there exists no accompanying relationship between the action of determining a synchronization reference and the action of receiving the first synchronization signal temporally. In one embodiment, the sentence “receiving a first synchronization signal from the synchronization reference determined” includes a meaning that: the first node firstly receives the first synchronization signal and then determines a synchronization reference.

In one embodiment, the first synchronization signal is on the first frequency.

In one embodiment, the second synchronization signal is on the first frequency.

In one embodiment, the first synchronization signal and the second synchronization signal are at a same

frequency.

In one embodiment, the first synchronization signal and the second synchronization signal are at different frequencies.

In one embodiment, the second synchronization signal is used to indicate a type of the synchronization reference.

In one subembodiment, a sidelink synchronization signal identity corresponding to the second synchronization signal is equal to 0, indicating that the type of the synchronization reference is GNSS.

In one subembodiment, a sidelink synchronization signal identity corresponding to the second synchronization signal is unequal to 0, indicating that the type of the synchronization reference is not GNSS.

In one embodiment, a sidelink synchronization signal identity corresponding to the first synchronization signal is equal to a sl-SSID indicated by a gnss-Sync-excluding SL-SyncConfig field for the first frequency that is indicated by the first message, indicating that a synchronization reference is a cell.

In one embodiment, a sidelink synchronization signal identity corresponding to the first synchronization signal is equal to 337, indicating that a synchronization reference is GNSS.

In one embodiment, if a transmitter of the first signal is a generator of the first message, the first message is transmitted via a direct path; if a transmitter of the first signal is not a generator of the first message, the first message is not transmitted via a direct path.

In one embodiment, a sidelink synchronization signal identity corresponding to the first synchronization signal is equal to 0.

In one embodiment, the first synchronization signal is from GNSS.

In one embodiment, the first synchronization signal is a GNSS signal.

In one embodiment, the first synchronization signal is a satellite signal.

In one embodiment, the first synchronization signal is from the satellite.

In one embodiment, the GNSS includes GPS and other satellite-based positioning systems like Beidou navigation satellite system.

In one embodiment, the first node is in RRC_CONNECTED state.

In one embodiment, the first node is in RRC_IDLE state.

In one embodiment, the first node is in RRC_INACTIVE state.

In one embodiment, the first node is in RRC_INACTIVE or RRC_IDLE state.

### Embodiment 2

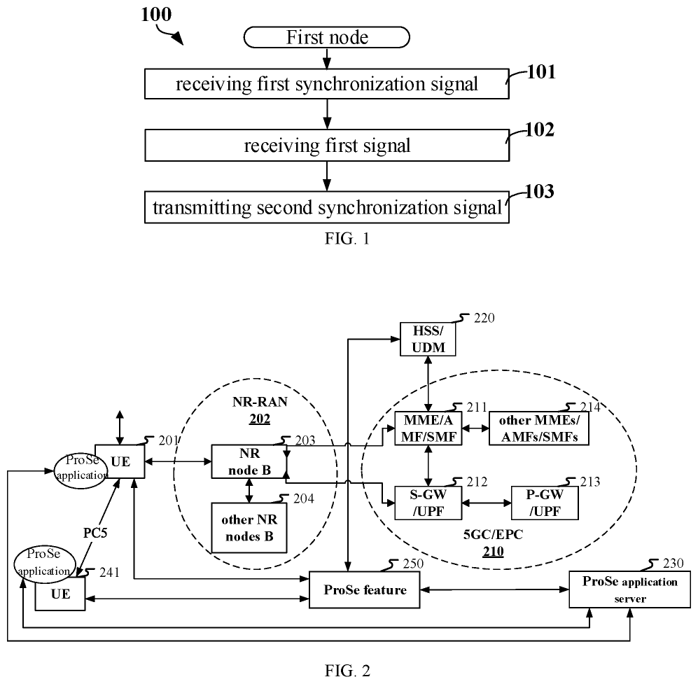

Embodiment 2 illustrates a schematic diagram of a network architecture according to one embodiment of the present application, as shown in FIG. 2. FIG. 2 is a diagram illustrating a V2X communication architecture of 5G NR, Long-Term Evolution (LTE), and Long-Term Evolution Advanced (LTE-A) systems. The 5G NR or LTE network architecture may be called a 5G System/Evolved Packet System (5GS/EPS) 200 or other appropriate terms.

The V2X communication architecture in Embodiment 2 may comprise a UE 201, a UE241, an NG-RAN 202, a 5G-Core Network/Evolved Packet Core (5GC/EPC) 210, a Home Subscriber Server/Unified Data Management(HSS/UDM) 220, a ProSe feature 250 and ProSe application server 230. The V2X communication architecture may be interconnected with other access networks. For simple description, the entities/interfaces are not shown. As shown in FIG. 2, the V2X communication architecture provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MIME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services. The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC ProSe user ID as well as allocating ProSe-restricted code-suffix pool.

In one embodiment, the UE201 and the UE241 are connected by a PC5 Reference Point.

In one embodiment, the ProSe feature 250 is connected to the UE 201 and the UE 241 respectively by PC3 Reference Points.

In one embodiment, the ProSe feature 250 is connected to the Pro Se application server 230 by a PC2 Reference Point.

In one embodiment, the ProSe application server 230 is connected with the ProSe application of the UE 201 and the ProSe application of the UE 241 respectively via a PCI Reference Point.

In one embodiment, the first node in the present application is the UE 201.

In one embodiment, the second node in the present application is the UE 241.

In one embodiment, the third node in the present application is the gNB 203.

In one embodiment, a radio link between the UE 201 and the UE 241 corresponds to a sidelink (SL) in the present application.

In one embodiment, a radio link from the UE 201 to the NR Node B is an uplink.

In one embodiment, a radio link from the NR Node B to the UE 201 is a downlink

In one embodiment, the UE 201 supports relay transmission.

In one embodiment, the UE 241 supports relay transmission.

In one embodiment, the UE 201 is a means of transportation including automobile.

In one embodiment, the UE 241 is a means of transportation including automobile.

In one embodiment, the gNB 203 is a MacroCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

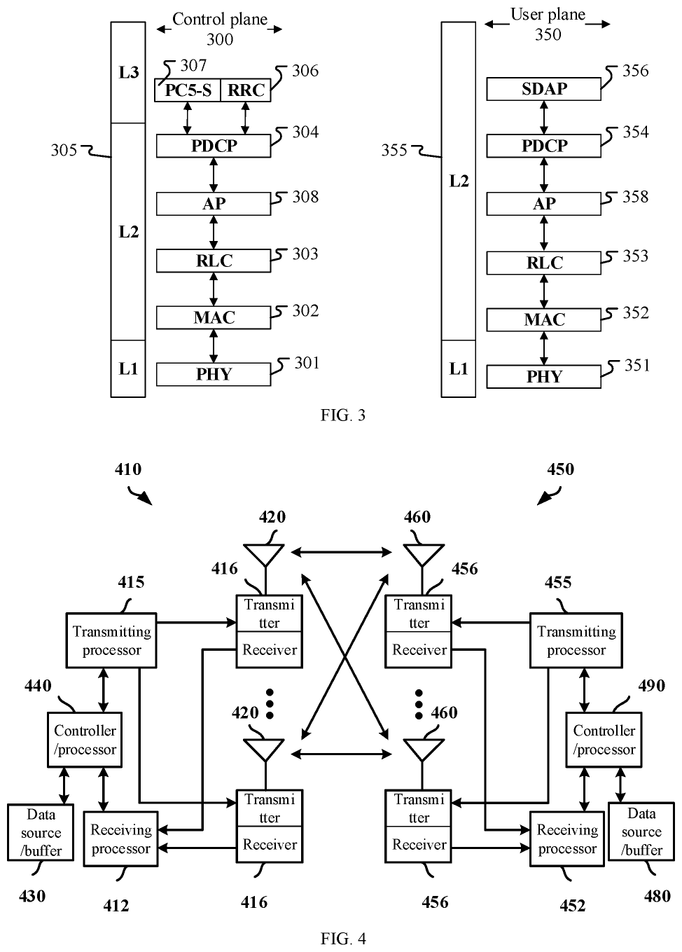

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The PC5 Signaling Protocol (PC5-S) sublayer307 is responsible for processing the signaling protocol at the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the

L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.). For a UE involved with relay services, its control plane can also comprise an adaption sublayer AP308, and its user plane can also comprise an adaption sublayer AP358. The introduction of the adaption layer is beneficial for lower layers such as the MAC or the RLC layer to multiple and/or distinguish data from multiple source UEs. For UE-UE communications relating to relay services, the adaption sublayer can be excluded. Besides, adaption sublayers AP308 and AP358 can respectively serve as sublayers of the PDCP304 and PDCP354. The RRC306 can be used for processing an RRC signaling of the Uu interface and a signaling of the PC5 interface.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first message in the present application is generated by the RRC306.

In one embodiment, the first sidelink MIB in the present application is generated by the PC5-RRC.

In one embodiment, the second sidelink MIB in the present application is generated by the PC5-RRC.

In one embodiment, the first synchronization signal in the present application is generated by the PHY 301.

In one embodiment, the second synchronization signal in the present application is generated by the PHY 301.

In one embodiment, the first signal in the present application is generated by the PHY301, or the MAC302, or the RLC303, or the RRC306 or the PC5-S307.

### Embodiment 4

Embodiment 4 illustrates a schematic diagram of a first communication device and a second communication

device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the first communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the first communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

Ina transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: receives a first message, the first message indicating a first frame number and corresponding first reference time; the first reference time including a first reference day, a first reference second and a first reference millisecond, and the first frame number being a non-negative integer less than 1024; transmits a second message, the second message comprising a second parameter, a second frame number and corresponding second reference time; the second reference time including the first reference day and the first reference second, and the second parameter indicating uncertainty of the second reference time, and the second frame number being a non-negative integer less than 1024; where the second parameter is generated in the first node.

In one embodiment, the first communication node 450 comprises a memory that stores computer readable instruction program, the computer readable instruction program generates an action when executed by at least one processor, which includes: receiving a first message, the first message indicating a first frame number and corresponding first reference time; the first reference time including a first reference thy, a first reference second and a first reference millisecond, and the first frame number being a non-negative integer less than 1024; transmitting a second message, the second message comprising a second parameter, a second frame number and corresponding second reference time; the second reference time including the first reference thy and the first reference second, and the second parameter indicating uncertainty of the second reference time, and the second frame number being a non-negative integer less than 1024; where the second parameter is generated in the first node.

In one embodiment, the first communication device 450 corresponds to the first node in the present application.

In one embodiment, the second communication device 410 corresponds to a second node in the present application.

In one embodiment, the first communication device 450 is a UE.

In one embodiment, the first communication device 450 is a vehicle-mounted terminal.

In one embodiment, the first communication device 450 is a relay.

In one embodiment, the second communication device 410 is a UE.

In one embodiment, the receiver 456 (comprising the antenna 460), the receiving processor 452 and the controller/processor 490 are used for receiving the first message in the present application.

In one embodiment, the receiver 456 (comprising the antenna 460), the receiving processor 452 and the controller/processor 490 are used for receiving the second signal in the present application.

In one embodiment, the receiver 456 (comprising the antenna 460), the receiving processor 452 and the controller/processor 490 are used for receiving the third signal in the present application.

In one embodiment, the receiver 456 (comprising the antenna 460), the receiving processor 452 and the controller/processor 490 are used for receiving the fourth signal in the present application. In one embodiment, the transmitter 456 (comprising the antenna 460), the transmitting processor 455 and

the controller/processor 490 are used for transmitting the second message in the present application.

In one embodiment, the transmitter 456 (comprising the antenna 460), the transmitting processor 455 and the controller/processor 490 are used for transmitting the first signal in the present application.

### Embodiment 5

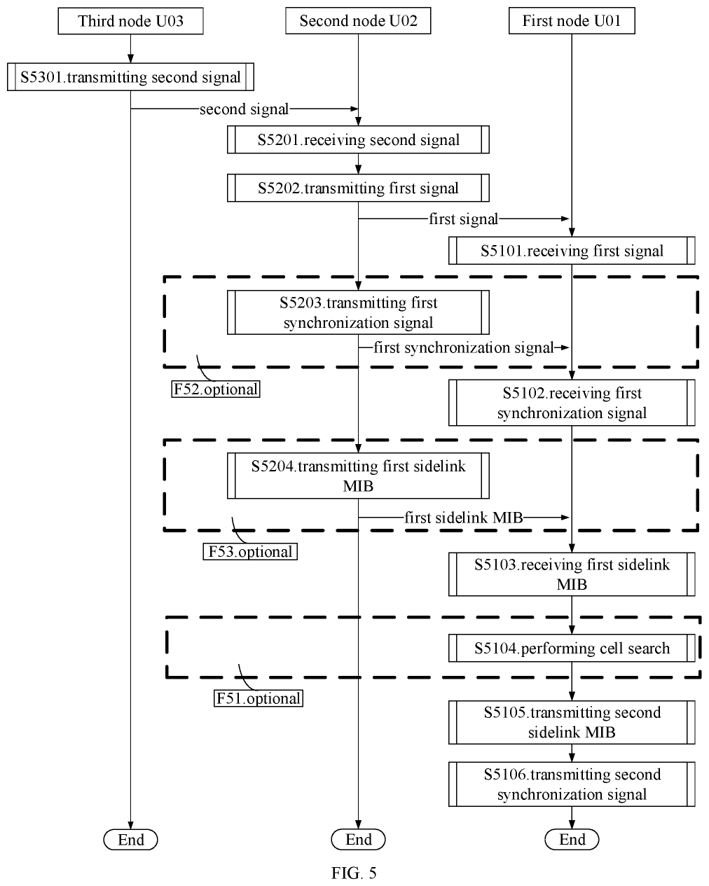

Embodiment 5 illustrates a flowchart of radio signal transmission according to one embodiment of the present application, as shown in FIG. 5. In FIG. 5, U01 corresponds to a first node in the present application, U02 corresponds to a second node in the present application, and a third node U03 is a serving cell or base station. It should be particularly noted that the order presented in this embodiment does not limit the order of signal transmissions or the order of implementations of the present application; herein, steps marked by the F51, F51 and F53 are optional.

The first node U01 receives a first signal in step S5101; and receives a first synchronization signal in step S5102; receives a first sidelink MIB in step S5103; and performs cell search in step S5104; transmits a second sidelink MIB in step S5105; and transmits a second synchronization signal in step S5106.

The second node U02 receives a second signal in step S5201; and transmits a first signal in step S5202; transmits a first synchronization signal in step S5203; and transmits a first sidelink MIB in step S5204.

The third node U03 transmits a second signal in step S5301.

In Embodiment 5, the first signal comprises a first message; the first node U01 determines a synchronization reference according to at least whether the first message is transmitted via a direct path; the first message indicating a first sidelink frequency list, the first sidelink frequency list comprising a first frequency, the first frequency being used for sidelink communication; a reception timing of the first node U01 for the first synchronization signal being used to determine a transmission timing of the second synchronization signal.

In one embodiment, in step S5102, the first node U01 receives a first synchronization signal from the synchronization reference determined.

In one embodiment, the sentence of receiving a first synchronization signal from the synchronization reference determined includes that: the first node U01 firstly determines a synchronization reference and then receives the first synchronization signal.

In one embodiment, the sentence of receiving a first synchronization signal from the synchronization reference determined includes that: the first node U01 firstly receives the first synchronization signal and then determines a synchronization reference.

In one embodiment, the sentence of receiving a first synchronization signal from the synchronization reference determined includes that: there does not exist a chronological order for the first node U01's receiving the first synchronization signal and determining a synchronization reference.

In one embodiment, the action of determining a synchronization reference is periodically performed.

In one embodiment, the action of determining a synchronization reference is event triggered.

In one embodiment, the first node U01 is a U2N relay UE.

In one embodiment, the first node U01 is a U2N remote UE.

In one embodiment, the second node U02 is a UE.

In one embodiment, the second node U02 is a U2N relay of the first node U01.

In one embodiment, the third node U03 is a serving cell of the first node U01.

In one embodiment, the third node U03 is a primary cell (PCell) of the first node U01.

In one embodiment, the third node U03 is a master cell group (MCG) of the first node U01.

In one embodiment, the third node U03 is a base station to which a PCell of the first node U01 corresponds or belongs.

In one embodiment, the third node U03 is a base station to which a PCell of the second node U02 corresponds or belongs.

In one embodiment, the third node U03 is not a serving cell of the first node U01.

In one embodiment, the third node U03 is not a primary cell (PCell) of the first node U01.

In one embodiment, the third node U03 is not a master cell group (MCG) of the first node U01.

In one embodiment, the third node U03 is not a base station to which a PCell of the first node U01 corresponds or belongs.

In one embodiment, the third node U03 is not a base station to which a PCell of the second node U02

corresponds or belongs.

In one embodiment, the third node U03 is a serving cell of the second node U02.

In one embodiment, the third node U03 is a primary cell (PCell) of the second node U02.

In one embodiment, the third node U03 is a master cell group (MCG) of the second node U02.

In one embodiment, the third node U03 is a base station to which a PCell of the second node U02 corresponds or belongs.

In one embodiment, the first node U01 and the second node U02 share a same PCell.

In one embodiment, a cell on which the first node U01 is camped is the third node U03.

In one embodiment, a cell on which the second node U02 is camped is the third node U03.

In one embodiment, a cell to which the first node U01 belongs is the third node U03.

In one embodiment, a cell to which the second node U02 belongs is the third node U03.

In one embodiment, there is an RRC connection between the first node U01 and the third node U03.

In one embodiment, there is an RRC connection between the second node U02 and the third node U03.

In one embodiment, there is no RRC connection between the first node U01 and the third node U03.

In one embodiment, there is no RRC connection between the second node U02 and the third node U03.

In one embodiment, the first node U01 applies system information from the third node U03.

In one embodiment, the second node U02 applies system information from the third node U03.

In one embodiment, the first node U01 is in communication with the third node U03 via an indirect path

In one embodiment, the first node U01 is in communication with the second node U02 via a sidelink.

In one embodiment, a direct unicast link is established between the first node U01 and the second node U02.

In one embodiment, the second signal is a downlink radio signal.

In one embodiment, a physical channel occupied by the second signal includes a physical downlink shared channel (PDSCH).

In one embodiment, the second signal bears the first message.

In one embodiment, the second signal carries the first message.

In one embodiment, the second signal comprises the first message.

In one embodiment, the first message is an RRC message.

In one embodiment, at least part of fields or all fields in the first message are forwarded to the first node U01 via the second node U02.

In one embodiment, the first message is transmitted to the first node U01 via a Uu interface.

In one embodiment, the second signal is transmitted periodically.

In one embodiment, the second signal is transmitted aperiodically.

In one embodiment, as a response to a request for the second signal by the second node U02, the second signal is transmitted.

In one embodiment, the second node U02 relays or forwards the first message.

In one embodiment, the second signal comprises a second message, the second message being a SIB12.

In one subembodiment, the first message comprises at least part of fields in the second message.

In one subembodiment, the first message comprises the second message.

In one subembodiment, the first message indicates that a SIB12 is being comprised.

In one embodiment, the step S5203 in F52 does not take place, and the first synchronization signal is

transmitted by a node other than the second node U02.

In one subembodiment, the transmitter of the first synchronization signal is GNSS, the first synchronization signal being a signal sent by GNSS.

In one subembodiment, the transmitter of the first synchronization signal is a UE, the first synchronization signal being a sidelink synchronization signal.

In one subembodiment, the transmitter of the first synchronization signal is a satellite, the first synchronization signal being a satellite signal.

In one embodiment, the step S5204 in F53 does not take place, and the first sidelink MIB is transmitted by a node other than the second node U02.

In one subembodiment, the transmitter of the first sidelink MIB is a UE.

In one embodiment, the first sidelink MIB is a MasterInformationBlockSidelink.

In one embodiment, the first sidelink MIB comprises 31 bits.

In one embodiment, the first sidelink MIB comprises a field indicating sidelink TDD configuration.

In one embodiment, the first sidelink MIB comprises an inCoverage field, and the inCoverage field comprised by the first sidelink MIB indicates whether in coverage; the inCoverage field comprised by the first sidelink

MIB being set to true indicates that the presence is in coverage of the network or that GNSS timing is chosen as a synchronization reference source.

In one subembodiment, the inCoverage field comprised by the first sidelink MIB being set to false indicates that the presence is not in coverage of the network, nor is GNSS timing chosen as a synchronization reference source.

In one embodiment, the first sidelink MIB comprises a field indicating a direct frame number.

In one embodiment, the first sidelink MIB comprises a field indicating a slot index.

In one embodiment, a logical channel occupied by the first sidelink MIB is a Sidelink Broadcast Control Channel (SBCCH).

In one embodiment, a physical channel occupied by the first sidelink MIB is a physical sidelink broadcast channel (PSBCH).

In one embodiment, the first synchronization signal is SLSS, and the first identity is SLSS ID.

In one embodiment, the first synchronization signal is S-SS, and the first identity is N_{ID}^{SL}.

In one embodiment, the first node U01 performs cell search to determine in coverage of at least a first cell;

herein, the first message is not transmitted via a direct path, and a synchronization priority order indicated by the first message is a base station, and the synchronization reference determined is a synchronization reference

User Equipment (UE).

In one embodiment, in step S5104, the first node U01 performs cell search and determines according to a result of the cell search in coverage of at least a first cell.

In one embodiment, the first cell belongs to the first frequency.

In one embodiment, the first cell is on the first frequency.

In one embodiment, the first cell is the transmitter of the first message.

In one embodiment, the first cell is a serving cell of the first node U01.

In one embodiment, the first cell is a primary cell (Pcell) of the first node U01.

In one embodiment, the first cell is a secondary cell (Scell) of the first node U01.

In one embodiment, the first cell is the third node U02.

In one embodiment, the base station is a gnbEnb.

In one embodiment, the base station is a gnb or Enb.

In one embodiment, the action of performing cell search to determine in coverage of at least a first cell includes: receiving a first downlink signal on a first cell, where a received quality for the first downlink signal meets the requirement for presence in coverage.

In one embodiment, the first downlink signal comprises a synchronization signal.

In one embodiment, the first downlink signal comprises a PBCH.

In one embodiment, the first downlink signal comprises a SS/PBCH.

In one embodiment, the action of performing cell search to determine in coverage of at least a first cell includes: searching for a SS/PBCH on the first frequency, where the SS/PBCH signal searched meets the requirement for presence in coverage, and it is determined that a cell corresponding to the SS/PBCH signal searched is the first cell.

In one subembodiment, the phrase of meeting the requirement for presence in coverage includes that a result of measurement of a signal received during the cell search procedure is greater than a first search threshold.

In one subembodiment, the phrase of meeting the requirement for presence in coverage includes that a result of measurement of a SS/PBCH signal received during the cell search procedure is greater than a first search threshold.

In one subembodiment, the phrase of meeting the requirement for presence in coverage includes that quality of a SS/PBCH signal received during the cell search procedure is greater than a first search threshold.

In one embodiment, the first search threshold is indicated by the network.

In one embodiment, the first search threshold is pre-defined.

In one embodiment, the action of performing cell search includes receiving a SIB 1.

In one embodiment, the SS/PBCH is an SSB.

In one embodiment, the SS/PBCH block is an SSB.

In one embodiment, the first message comprises a sl-SyncPriority field, and the sl-SyncPriority field comprised by the first message indicates the synchronization priority order.

In one embodiment, the synchronization reference determined is a UE.

In one embodiment, the synchronization reference determined is a transmitter of the first synchronization signal.

In one embodiment, the synchronization reference determined is a SyncRef UE.

In one embodiment, the synchronization reference determined is the second node U02.

In one embodiment, the first message is not transmitted via a direct path, namely, the first message is transmitted via forwarding or relay.

In one embodiment, the first message is not transmitted via a direct path, namely, the first message is transmitted via forwarding of the second node U02.

In one embodiment, the first message is not transmitted via a direct path, namely, the first message is transmitted via an indirect path.

In one embodiment, the first node U01 fails to detect a cell on a first frequency in step S5104; the first message being not transmitted via a direct path; a transmitter of the first synchronization signal being determined as a synchronization reference; the synchronization reference determined being a synchronization reference UE; and a synchronization priority order indicated by the first message being a base station;

herein, the first message comprises first transmission timing information and second transmission timing information; the first transmission timing information is used to indicate transmission timing information of the second synchronization signal; the second transmission timing information is used to determine a sidelink synchronization signal identity of the second synchronization signal; and the second transmission timing information is related to Global Navigation Satellite System (GNSS).

In one subembodiment, the action of failing to detect a cell on a first frequency means that the first node U01 is not in coverage on the first frequency.

In one subembodiment, the action of failing to detect a cell on a first frequency means that the first node U01 is out of coverage on the first frequency.

In one subembodiment, the synchronization reference determined is a SyncRef UE.

In one subembodiment, the transmitter of the first synchronization signal is a UE.

In one subembodiment, the transmitter of the first synchronization signal is the second node U02.

In one subembodiment, a synchronization priority order indicated by a sl-SyncPriority field of the first message is a base station.

In one subembodiment, the first node U01 does not detect a suitable cell on the first frequency.

In one subembodiment, the first node U01 does not detect an acceptable cell on the first frequency.

In one subembodiment, the first node U01 does not detect a synchronization signal of a suitable cell on the first frequency.

In one subembodiment, the first node U01 does not detect a synchronization signal of an acceptable cell on the first frequency.

In one subembodiment, the first node U01 does not detect an SSB of a suitable cell on the first frequency.

In one subembodiment, the first node U01 does not detect an SSB of an acceptable cell on the first frequency.

In one subembodiment, the first transmission timing information indicates a number of sidelink SSBs transmitted within one period.

In one subembodiment, the first transmission timing information indicates a slot offset of a start of a sidelink

SSB period to a first sidelink SSB.

In one subembodiment, the first transmission timing information indicates a slot interval of multiple adjacent sidelink SSBs.

In one subembodiment, the first transmission timing information is sl-SSB-TimeAllocation1.

In one subembodiment, the first transmission timing information is sl-SSB-TimeAllocation2.

In one subembodiment, the second transmission timing information indicates a number of sidelink SSBs transmitted within one period.

In one subembodiment, the second transmission timing information indicates a slot offset of a start of a sidelink SSB period to a first sidelink SSB.

In one subembodiment, the second transmission timing information indicates a slot interval of multiple adjacent sidelink SSBs.

In one subembodiment, the second transmission timing information is sl-SSB-TimeAllocation3.

In one subembodiment, a transmission timing of the second synchronization signal satisfies a transmission timing indicated by the second transmission timing information.

In one subembodiment, the second transmission timing information is determined as transmission timing

information of the second synchronization signal.

In one subembodiment, transmission timing information of the second synchronization signal is the first transmission timing information.

In one subembodiment, a transmission timing of the second synchronization signal is determined by the first transmission timing information.

In one subembodiment, a transmission timing of the second synchronization signal is indicated by the first transmission timing information.

In one subembodiment, the first node selects a slot indicated by the first transmission timing information.

In one subembodiment, the first node selects a slot indicated by the first transmission timing information for transmitting the second synchronization signal.

In one subembodiment, the sentence that the second transmission timing information is related to Global Navigation Satellite System (GNSS) includes the following meaning: when a synchronization reference UE selects GNSS as a synchronization reference, a slot indicated by the second transmission timing information is used for transmitting a sidelink synchronization reference signal.

In one subembodiment, the sentence that the second transmission timing information is related to Global Navigation Satellite System (GNSS) includes the following meaning: a synchronization reference determined by the first node U01 is a synchronization reference UE, and the synchronization reference UE selects GNSS as a synchronization reference, and the synchronization reference UE uses a slot indicated by the second transmission timing information for transmitting a sidelink synchronization reference signal.

In one subembodiment, the sentence that the second transmission timing information is related to Global Navigation Satellite System (GNSS) includes the following meaning: a synchronization reference determined by the first node U01 is the transmitter of the first synchronization signal, the transmitter of the first synchronization signal chooses GNSS as a synchronization reference, and the transmitter of the first synchronization signal uses a slot indicated by the second transmission timing information for transmitting the first synchronization signal. In one subembodiment, the sentence that the second transmission timing information is related to Global Navigation Satellite System (GNSS) includes the following meaning: a synchronization reference determined by the first node U01 is the transmitter of the first synchronization signal, when the transmitter of the first synchronization signal is configured without the second transmission timing information and out of coverage of the network and chooses GNSS as a synchronization reference, a sidelink MIB transmitted by the transmitter of the first synchronization signal indicates in coverage.

In one subembodiment, the sentence that the second transmission timing information is related to Global Navigation Satellite System (GNSS) includes the following meaning: a synchronization reference determined by the first node U01 is the transmitter of the first synchronization signal, when the transmitter of the first synchronization signal is configured with the second transmission timing information and out of coverage of the network and chooses GNSS as a synchronization reference, a sidelink MIB transmitted by the transmitter of the first synchronization signal indicates out of coverage.

In one embodiment, the first sidelink MIB is transmitted along with the first synchronization signal.

In one embodiment, the first sidelink MIB and the first synchronization signal form a sidelink Synchronization Signal and PBCH block (SSB).

In one embodiment, the first sidelink MIB and the first synchronization signal form a sidelink S-SS/PSBCH block.

In one embodiment, a PSBCH is only used for transmitting or bearing sidelink MIBs.

In one embodiment, the meaning of the action of performing cell search is to detect a cell.

In one embodiment, the first node U01 performs cell search to determine not in coverage of a first cell but in coverage of a second cell; the first cell is a generator of the first message; and the first cell is a Primary Cell (PCell) or a serving cell of the first node; the second cell is a cell other than the PCell or the serving cell of the first node; the first cell and the second cell are both on the first frequency; the first frequency is a primary frequency;

herein, the first message is not transmitted via a direct path, and a synchronization priority order indicated by the first message is a base station, and the synchronization reference determined is the second cell.

In one subembodiment, the first node U01 performs cell search in step S5104, and a cell detected is the second cell, the second cell being different from the first cell.

In one subembodiment, whether the first cell is a PCell or a serving cell of the first node U01 depends on RRC state of the first node U01.

In one subembodiment, when the first node U01 is in RRC_Connected state, the first cell is a PCell of the first node U01.

In one subembodiment, when the first node U01 is in an RRC state other than RRC Connected state, the first cell is a serving cell of the first node U01.

In one subembodiment, the sentence that the second cell is a cell other than the PCell or the serving cell of the first node means that: the second cell is neither the PCell of the first node nor the serving cell of the first node.

In one subembodiment, the sentence that the second cell is a cell other than the PCell or the serving cell of the first node means that: the first cell is the PCell or the serving cell of the first node, the second cell being different from the first cell.

In one subembodiment, the sentence that the second cell is a cell other than the PCell or the serving cell of the first node means that: when the first node U01 is in RRC Connected state, the second cell is not a PCell of the first node U01; when the first node U01 is in an RRC state other than RRC Connected state, the second cell is not a serving cell of the first node U01.

In one subembodiment, a frequency on which the first cell works is the first frequency.

In one subembodiment, a frequency on which the second cell works is the first frequency.

In one subembodiment, the first frequency is a frequency on which a PCell of the first node U01 works.

In one subembodiment, the primary frequency is a frequency on which a PCell of the first node U01 works.

In one subembodiment, the primary frequency is a frequency on which a serving cell of the first node U01 works.

In one subembodiment, the second cell is an SCell of the first node.

In one subembodiment, the second cell is a cell other than an MCG of the first node.

In one subembodiment, the second cell is an SCell in an MCG of the first node.

In one subembodiment, in step S5104, the first node U01 fails to detect a reference signal of the first cell; and detects that a received quality of a SS/PBCH of the second cell meets the requirement for presence in coverage.

In one subembodiment, in step S5104, the first node U01 detects that the received quality of a SS/PBCH of the first cell does not meet the requirement for presence in coverage; and detects that a received quality of a SS/PBCH of the second cell meets the requirement for presence in coverage.

In one subembodiment, the synchronization reference determined by the first node is the second cell.

In one embodiment, an advantage of the above method is that: when a first node receives a first message of a PCell or a serving cell not in a direct way, and the PCell or the serving cell of the first node is not in coverage, but the first node is in coverage of an SCell, the first node chooses the SCell rather than the PCell as a synchronization reference for better obtaining correct timing information.

In one embodiment, the first node U01 performs cell search to determine in coverage of the first frequency; the first frequency is a frequency other than a primary frequency or a secondary frequency;

herein, the first message is not transmitted via a direct path, and the synchronization reference determined is the first frequency.

In one subembodiment, in step S5104, the first node U01 detects a cell that meets the requirement for

presence in coverage on the first frequency.

In one subembodiment, the first frequency is not a primary frequency of the first node U01, nor is it a secondary frequency of the first node U01.

In one subembodiment, the first node U01 only has a primary frequency but has no secondary frequency and the first frequency is not the primary frequency of the first node U01.

In one subembodiment, the first node U01 only has a PCell but has no SCell, the first frequency being a frequency other than a frequency on which the PCell of the first node U01 works.

In one embodiment, the sentence of performing cell search to determine in coverage of the first frequency comprises: performing cell search, and detecting a cell that meets the requirement for presence in coverage on the first frequency.

In one embodiment, the sentence of performing cell search to determine in coverage of the first frequency comprises: performing cell search, and detecting a suitable cell on the first frequency.

In one embodiment, the sentence of performing cell search to determine in coverage of the first frequency comprises: detecting an SSB (SS/PBCH) on the first frequency, and a received quality of the SSB (SS/PBCH) detected meeting the requirement for presence in coverage.

In one embodiment, the sentence of performing cell search to determine in coverage of the first frequency comprises: detecting a cell-defining SSB on the first frequency, and a received quality of the cell-defining SSB detected meeting the requirement for presence in coverage.

In one embodiment, the sentence that the synchronization reference determined is the first frequency includes that the synchronization reference determined is a cell detected on the first frequency.

In one embodiment, the sentence that the synchronization reference determined is the first frequency includes that the synchronization reference determined is a synchronization signal detected on the first frequency.

In one subembodiment, the received quality of the synchronization signal detected meets the requirement for presence in coverage.

In one subembodiment, received qualities of both the synchronization signal detected and a PBCH transmitted along with the synchronization signal detected meet the requirement for presence in coverage.

In one subembodiment, the transmitter of the synchronization signal detected is not a generator of the first message.

In one embodiment, the sentence that the synchronization reference determined is the first frequency includes that the synchronization reference determined is a SS/PBCH detected on the first frequency, and a received quality of the SS/PBCH can be determined to be in coverage of the first frequency.

In one embodiment, an advantage of the above method is that: when a first node receives a first message of a PCell or a serving cell not in a direct way, and the PCell or the serving cell of the first node is not in coverage, the first node chooses a first frequency as a synchronization reference for avoidance of mistakenly determining the PCell or the serving cell as the synchronization reference.

In one embodiment, the second sidelink MIB is a MasterinformationBlockSidelink.

In one embodiment, the second sidelink MIB comprises 31 bits.

In one embodiment, the second sidelink MIB comprises a field indicating sidelink TDD configuration.

In one embodiment, the second sidelink MIB comprises an inCoverage field, and the inCoverage field comprised by the second sidelink MIB indicates whether in coverage; the inCoverage field comprised by the second sidelink MIB being set to true indicates that the presence is in coverage of the network or that GNSS timing is chosen as a synchronization reference source.

In one subembodiment, the inCoverage field comprised by the second sidelink MIB being set to false indicates that the presence is not in coverage of the network, nor is GNSS timing chosen as a synchronization reference source.

In one embodiment, the second sidelink MIB comprises a field indicating a direct frame number.

In one embodiment, the second sidelink MIB comprises a field indicating a direct slot index.

In one embodiment, a logical channel occupied by the second sidelink MIB is a Sidelink Broadcast Control Channel (SBCCH).

In one embodiment, a physical channel occupied by the second sidelink MIB is a physical sidelink broadcast channel (PSBCH).

In one embodiment, the second sidelink MIB and the second synchronization signal are transmitted in a same SL-SSB.

In one embodiment, the second sidelink MIB and the second synchronization signal belong to a same sidelink SSB.

In one embodiment, when the first node U01 is in coverage at the first frequency and the first message is not transmitted via a direct path, the second sidelink MIB does not indicate in coverage; when the first node U01 is in coverage at the first frequency, and the first message is transmitted via a direct path, the second sidelink MIB indicates in coverage.

In one subembodiment, the first node U01 detects a cell that meets the requirement for presence in coverage on the first frequency.

In one subembodiment, the first node U01 detects a signal that meets the requirement for presence in coverage on the first frequency.

In one subembodiment, the first node U01 detects an SSB that meets the requirement for presence in coverage on the first frequency.

In one subembodiment, the first node U01 detects a SS/PBCH that meets the requirement for presence in coverage on the first frequency.

In one subembodiment, the sentence that the second sidelink MIB does not indicate in coverage means that an inCoverage field in the second sidelink MIB is set to false.

In one subembodiment, the sentence that the second sidelink MIB indicates in coverage means that an

inCoverage field in the second sidelink MIB is set to true.

In one embodiment, the sentence that GNSS is determined as a synchronization reference means that the synchronization reference determined is GNSS.

In one embodiment, the second transmission timing information indicates a number of sidelink SSBs transmitted within one period.

In one embodiment, the second transmission timing information indicates a slot offset of a start of a sidelink SSB period to a first sidelink SSB.

In one embodiment, the second transmission timing information indicates a slot interval of multiple adjacent sidelink SSBs.

In one embodiment, the second transmission timing information is sl-SSB-TimeAllocation3.

In one embodiment, the sentence that the second transmission timing information is used to indicate transmission timing information of the second synchronization signal includes that: a transmission timing of the second synchronization signal satisfies a timing indicated by the second transmission timing information.

In one embodiment, the sentence that the second transmission timing information is used to indicate transmission timing information of the second synchronization signal includes that: a slot occupied by the second synchronization signal is determined by the second transmission timing information.

In one embodiment, the sentence that the second transmission timing information is used to indicate transmission timing information of the second synchronization signal includes that: the second transmission timing information determines a slot occupied by the second synchronization signal.

In one embodiment, the sentence that the second transmission timing information is used to indicate

transmission timing information of the second synchronization signal includes that: the second transmission timing information is transmission timing information of the second synchronization signal.

In one embodiment, the sentence that the second transmission timing information is used to indicate transmission timing information of the second synchronization signal includes that: the first node U01 transmits the second synchronization signal using information indicated by the second transmission timing information.

In one embodiment, the first node U01 performs cell search to determine in coverage of at least a first cell;

herein, the first message is transmitted via a direct path, and a synchronization priority order indicated by the first message is a base station, and the synchronization reference determined is the generator of the first message.

In one embodiment, the first node U01 performs cell search to determine in coverage of at least a first cell; herein, the first message is transmitted via a direct path, and a synchronization priority order indicated by the first message is a base station, and the synchronization reference determined is a PCell of the first node U01.

In one embodiment, cell search is performed to determine not in coverage of a first cell but in coverage of a second cell; the first cell is a generator of the first message; the first cell is a PCell of the first node U01; the second cell is not a PCell of the first node U01; the first cell and the second cell are both on the first frequency; the first frequency is a primary frequency;

herein, the first message is transmitted via a direct path, and a synchronization priority order indicated by the first message is a base station, and the synchronization reference determined is the first cell.

In one subembodiment, the second cell is not a serving cell of the first node U01.

In one subembodiment, the second cell is an SCell of the first node U01.

In one embodiment, the second node U02 receives a second synchronization signal and a second sidelink MIB, and the second node provides relay service to the first node U01; when a first condition set is satisfied, the transmitter of the second synchronization signal and the second sidelink MIB is not determined as a synchronization reference; a synchronization priority order indicated by the first message is a base station.

In one subembodiment, the first condition set being satisfied means that any condition in the first condition set is satisfied.

In one subembodiment, the first condition set comprises that the second sidelink MIB does not indicate in coverage.

In one subembodiment, the first condition set comprises that the first message is not transmitted via a direct path.

In one subembodiment, the first condition set comprises that a sidelink synchronization signal identity corresponding to the second synchronization signal belongs to a sidelink synchronization signal identity set out of coverage.

### Embodiment 6

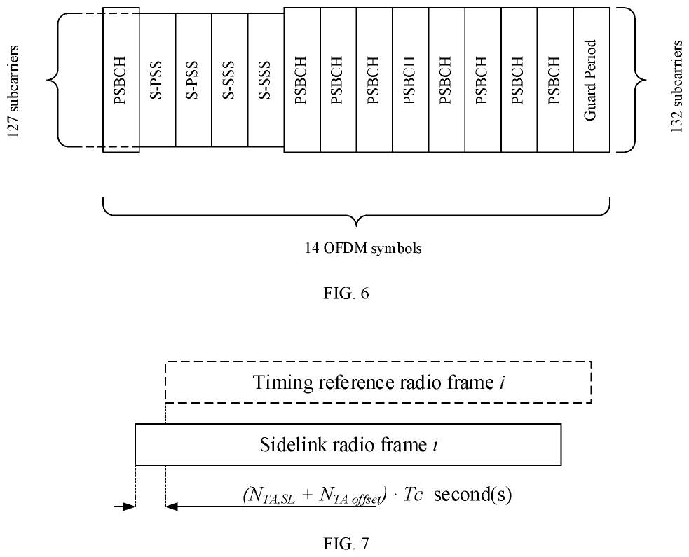

Embodiment 6 illustrates a schematic diagram of a sidelink synchronization signal block? according to one embodiment of the present application, as shown in FIG. 6.

FIG. 6 illustrates a structure of a S-SS/PSBCH block with a normal cyclic prefix (CP), where a sidelink 5-SS/PSBCH block comprises a Sidelink-Primary Synchronization Signal (S-PSS), a Sidelink-Secondary Synchronization Signal (S-SSS) and a PSBCH.

In one embodiment, a sidelink synchronization signal (SLSS), i.e., an S-SS, includes an S-PSS and an S-SSS.

In one embodiment, the S-SS/PSBCH block is a smallest unit of transmission.

In one embodiment, a sidelink synchronization signal (SLSS) is transmitted accompanied with a PSBCH.

In one embodiment, a S-SS/PSBCH occupies 13 OFDM symbols in time domain, and each S-SS/PSBCH block is followed by an OFDM symbol as a Guard Period (GP); each of an S-PSS and an S-SSS occupies 127 subcarriers in frequency domain; a PSBCH occupies 132 subcarriers in frequency domain.

In one embodiment, a sequence generating sidelink synchronization signals (SLSS) is determined by a sidelink synchronization signal identity, and a sidelink synchronization signal identity can uniquely generate one sequence for generating SLSS; there are a total of 672 unique sidelink synchronization signal identities. The 672 unique sidelink synchronization signal identities are identified by integers from 0 to 671; and the 672 sidelink synchronization signal identities can also be called 672 unique physical layer sidelink identities; a sidelink synchronization signal identity can be expressed in SLSS ID or SLSS ID or NE, with a value being an integer ranging from 0 to 671.

In one embodiment, a value of a sidelink synchronization signal identity corresponding to a sidelink synchronization signal transmitted by a UE in coverage is an integer ranging from 0 to 335; a value of a sidelink synchronization signal identity corresponding to a sidelink synchronization signal transmitted by a UE out of coverage is an integer ranging from 336 to 671.

In one embodiment, sequences generating Sidelink-Primary Synchronization Signals (S-PSS) are binary sequences with a length of 127, where whether any bit of the binary sequences has a value of 0 or 1 is determined by a first function with the sidelink synchronization signal identity as an input.

In one embodiment, sequences generating Sidelink-Secondary Synchronization Signals (S-SSS) are binary sequences with a length of 127, where whether any bit of the binary sequences has a value of 0 or 1 is determined by a second function with the sidelink synchronization signal identity as an input.

In one embodiment, DM-RS can also be comprised in time-frequency resources occupied by a 5-SS/PSBCH.

### Embodiment 7

Embodiment 7 illustrates a schematic diagram of a transmission timing according to one embodiment of the present application, as shown in FIG. 7.

In one embodiment, the synchronization reference is used to determine a transmission timing of a sidelink radio frame.

In one embodiment, the synchronization reference is used to determine a transmission time of a sidelink radio frame.

In one embodiment, a reception timing of the first synchronization signal is used to determine a transmission timing of the second synchronization signal.

In one embodiment, a reception timing of the first synchronization signal is used to determine a transmission timing of a sidelink signal transmitted by the first node on the first frequency.

In one embodiment, a reception timing of a synchronization signal from a synchronization reference is used to determine a transmission timing of the second synchronization signal.

In one embodiment, a reception timing of a synchronization signal from a synchronization reference is used to determine a transmission timing of a sidelink signal transmitted by the first node on the first frequency.

In one embodiment, transmitting a sidelink radio frame i from a first UE shall start (N_{TA,SL}+N_{TA,offset}) T_{c} second(s) before a start of a timing reference frame corresponding to the first UE.

In one embodiment, the first UE is not required to receive a sidelink or downlink transmission earlier than the value of N_{TA,offset} after an end of a sidelink transmission.

In one embodiment, for sidelink transmission, the first UE has a first serving cell that meets S criterion, where the S criterion is defined by the 3GPP TS38.304, a timing of a reference radio frame i is equal to that of a downlink radio frame i of the first serving cell, and an uplink carrier frequency of the first serving cell is equal to the first frequency; where the value of N_{TA,offset} is defined by 3GPP TS 38.211, Section 4.3.1.

In one subembodiment, the sentence that the first UE has a first serving cell that meets S criterion includes a meaning that: a synchronization reference for the first UE is a cell.

In one subembodiment, the sentence that the first UE has a first serving cell that meets S criterion includes a meaning that: a synchronization reference for the first UE is a PCell of the first UE.

In one subembodiment, the sentence that the first UE has a first serving cell that meets S criterion includes a meaning that: a synchronization reference for the first UE is a serving cell of the first UE.

In one subembodiment, the sentence that the first UE has a first serving cell that meets S criterion includes a meaning that: a synchronization reference for the first UE is the first frequency.

In one subembodiment, the reference radio frame i is any reference radio frame.

In one subembodiment, the reference radio frame i is an i-th reference radio frame, where i is a non-negative integer less than 1024.

In one embodiment, for sidelink transmission, the first UE has no first serving cell that meets S criterion, where the S criterion is defined by the 3GPP TS38.304, and a timing of a reference radio frame i is implicitly obtained according to 3GPP, TS38.213, Section 4.2; the value of N_{TA,offset} is equal to 0.

In one subembodiment, the reference radio frame i is any reference radio frame.

In one subembodiment, the reference radio frame i is an i-th reference radio frame, where i is a non-negative integer less than 1024.

In one embodiment, i is a non-negative integer less than 1024.

In one embodiment, N_{TA,SL} is equal to 0.

In one embodiment, the first UE corresponds to the first node in the present application.

In one embodiment, the first UE is any UE.

In one embodiment, the first UE is any UE that performs or supports sidelink communications.

In one embodiment, the first UE is any UE that performs sidelink communications on the first frequency.

In one embodiment, T_{c}=1/(Δfₘₐₓ·N_{f}), where Δfₘₐₓ=480·10³ Hz, N_{f}=4096.

In one embodiment, there exists a fixed temporal relation between a start of a sidelink radio frame i and a start of a timing reference radio frame i.

In one embodiment, a sidelink radio frame i starts N_{TA,offset} before a start of a timing reference radio frame i.

In one embodiment, N_{TA,offset} is equal to 0.

In one embodiment, N_{TA,offset} is indicated by the network.

In one embodiment, N_{TA,offset} is defined by the 3GPP TS38.213, Section 4.2.

In one embodiment, the timing reference radio frame i is a timing reference radio frame i received by the first UE.

In one embodiment, the timing reference radio frame i is a radio frame i received by the first UE from a synchronization reference.

In one embodiment, the timing reference radio frame i is a radio frame i received by the first UE from a synchronization reference source.

In one embodiment, a start time at which the timing reference radio frame i is received is equal to a start

time at which a sidelink radio frame i is transmitted.

In one embodiment, a start time of the timing reference radio frame i at a receiving end is equal to a start time of a sidelink radio frame i.

In one embodiment, the timing reference radio frame i is a radio frame transmitted by the synchronization reference determined.

In one embodiment, the timing reference radio frame i is a radio frame where a synchronization signal transmitted by the synchronization reference determined is present.

In one embodiment, the timing reference radio frame i is a radio frame where the first synchronization signal is present.

In one embodiment, when the synchronization reference determined is GNSS, a transmission timing of a sidelink radio frame is determined by UTC time indicated by GNSS.

In one embodiment, the action of determining a synchronization reference comprises receiving a timing reference radio frame i and determining a reception time of the timing reference radio frame i.

In one embodiment, the action of determining a synchronization reference comprises receiving a timing reference radio frame i and determining a transmission time of a sidelink radio frame i according to a reception time of the timing reference radio frame i, where i is any non-negative integer less than 1024.

In one embodiment, the action of determining a synchronization reference comprises determining a synchronization reference source.

In one embodiment, the action of determining a synchronization reference comprises determining a synchronization reference source and keeping in sync with a synchronization signal transmitted by the synchronization reference source.

In one embodiment, the action of determining a synchronization reference comprises determining a synchronization reference source and determining a transmission timing of a transmitted sidelink signal according to a synchronization signal transmitted by the synchronization reference source.

In one embodiment, the action of determining a synchronization reference comprises determining a synchronization reference source and determining a timing of a slot according to a synchronization signal transmitted by the synchronization reference source.

In one embodiment, the action of determining a synchronization reference comprises determining a synchronization reference source and determining a timing of a frame according to a synchronization signal transmitted by the synchronization reference source.

### Embodiment 8

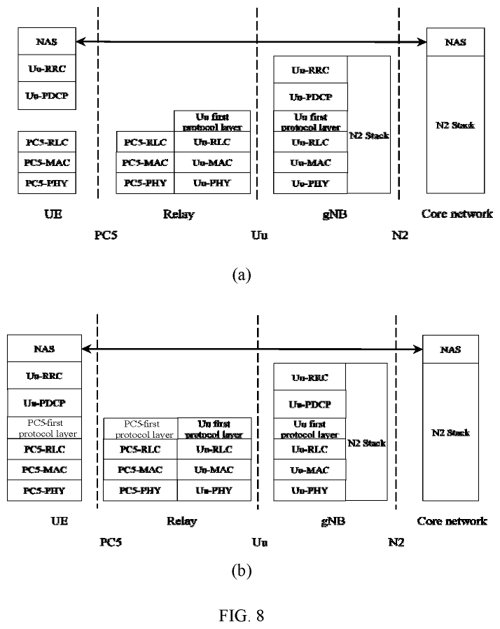

Embodiment 8 illustrates a schematic diagram of a protocol stack of relay communications according to one embodiment of the present application, as shown in FIG. 8. FIG. 8 comprises two kinds of implementations given in (a) and (b).

In the protocol stack shown in FIG. 8(a), first protocol layers are terminated at a relay node and a gNB node.

In the protocol stack shown in FIG. 8(b), first protocol layers are respectively terminated at a UE and a relay node, a relay node and a gNB node.

In one embodiment, the UE in FIG. 8 corresponds the first node in the present application, and the relay in FIG. 8 corresponds to the second node in the present application; the gNB in FIG. 8 corresponds to a generator of the first message in the present application.

In one embodiment, with Embodiment 3 as the foundation, Embodiment 8 illustrates a protocol stack and interfaces related to the relay node; In Embodiment 8, NAS is a Non-Access Stratum; Uu-RRC is an RRC protocol of a Uu interface; Uu-PDCP is a PDCP layer of the Uu interface; Uu-RLC is an RLC layer of the Uu interface; Uu-MAC is a MAC layer of the Uu interface; Uu-PHY is a physical layer of the Uu interface; PC5-RLC is an RLC layer of a PC5 interface; PC5-MAC is a MAC layer of the PC5 interface; PC5-PHY is a physical layer of the PC5 interface; N2 Stack is a protocol stack of a N2 interface, where the N2 interface is an interface between a gNB and a core network; a Uu first protocol layer is a first protocol layer of the Uu interface; a PC5-first protocol layer is a first protocol layer of the PC5 interface.

In one embodiment, a communication interface between the UE and the gNB in FIG. 8 is a Uu interface.

In one embodiment, a communication interface between the relay and the gNB in FIG. 8 is a Uu interface.

In one embodiment, a communication interface between the UE and the relay in FIG. 8 is a PC5 interface.

In one embodiment, the first protocol layer is an adaptation layer.

In one embodiment, the first protocol layer is a protocol layer between a PDCP layer and an RLC layer.

In one embodiment, the first protocol layer is used for multiplexing data of multiple radio bearers onto a same Uu-RLC bearer/entity.

In one embodiment, the first protocol layer is used for XXX data of multiple radio bearers multiplexed on a same Uu-RLC bearer/entity on corresponding PC5-RLC bearer/entity.

In one embodiment, the first protocol layer is used for associating one or more PC5-RLC entities with a Uu-RLC entity.

In one embodiment, the PC5-first protocol layer in FIG. 8 is an adaptation layer of the PC5 interface.

In one embodiment, the Uu first protocol layer in FIG. 8 is an adaptation layer of the Uu interface.

In one embodiment, the UE and relay in FIG. 8 select the implementation (a) or (b) based on configurations by the network.

In one embodiment, the UE and relay in FIG. 8 select the implementation (a) or (b) through signaling negotiation.

In one embodiment, the first signal is a signal between the UE and the relay, generated by a PC5-PHY or a PC5-MAC or a PC5-RLC or a PC5-first protocol layer.

In one embodiment, the second signal is a signal between the relay and the gNB, generated by a Uu-PHY or a Uu-MAC or a Uu-RLC or a Uu-first protocol layer.

In one embodiment, the first message is generated by the gNB, the first message being a Uu-RRC message.

In one embodiment, the second message is generated by the gNB, the first message being a Uu-RRC message.

In one embodiment, the first message is transparent to the relay.

In one embodiment, the first message is transmitted to the UE via a PC5-RRC message of the relay.

In one embodiment, the UE in FIG. 8 is a U2N remote UE.

In one embodiment, the relay in FIG. 8 is a U2N relay UE.

### Embodiment 9

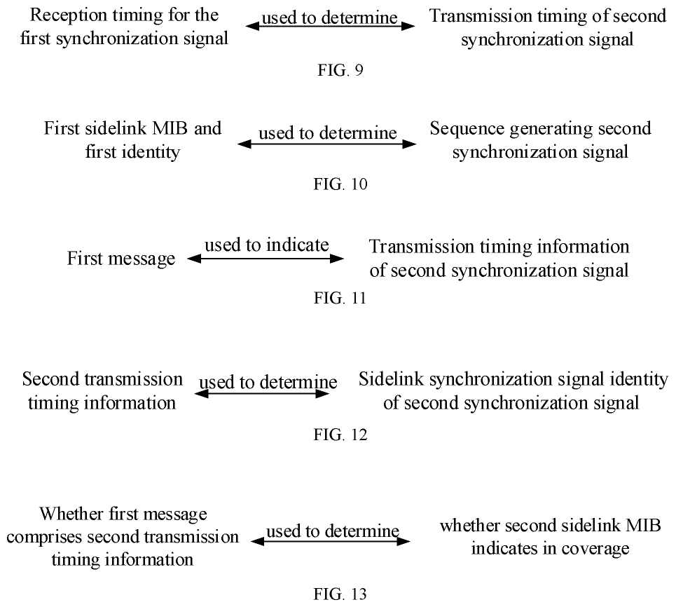

Embodiment 9 illustrates a schematic diagram of a reception timing for a first synchronization signal being used to determine a transmission timing of a second synchronization signal according to one embodiment of the present application, as shown in FIG. 9.

In one embodiment, a transmission time of the second synchronization signal is equal to a reception time of the first synchronization signal.

In one embodiment, a transmission time of the second synchronization signal is equal to a sum of a reception time of the first synchronization signal and a first time offset, where the first time offset is a non-zero real number.

In one embodiment, the first time offset is fixed.

In one embodiment, the first time offset is designated by the system.

In one embodiment, the first time offset is indicated by the first message.

In one embodiment, the first message or SidelinkPreconfigNR indicates i-th transmission timing information and j-th transmission timing information, where a transmission timing of the first synchronization signal is determined by the i-th transmission timing information, and the j-th transmission timing information is determined as a transmission timing of the second synchronization signal, i being different from j.

In one subembodiment, the i-th transmission timing information is sl-SSB-TimeAllocation1; the j-th transmission timing information is sl-SSB-TimeAllocation2.

In one subembodiment, the i-th transmission timing information is sl-SSB-TimeAllocation2; the j-th transmission timing information is sl-SSB-TimeAllocation1.

In one subembodiment, a reception time of the first synchronization signal is used to determine whether a transmission timing of the first synchronization signal depends on the i-th transmission timing information or the j-th transmission timing information.

In one embodiment, a reception timing of the first synchronization signal is a start time of a slot where the first synchronization signal is present.

In one embodiment, a reception timing of the first synchronization signal is a start time of a radio frame where the first synchronization signal is present.

In one embodiment, a transmission timing of the second synchronization signal is a start time of a slot where the second synchronization signal is present.

In one embodiment, a transmission timing of the second synchronization signal is a start time of a radio frame where the second synchronization signal is present.

In one embodiment, a reception timing of the first synchronization signal determines a radio frame where the first synchronization signal is present; the second synchronization signal and the first synchronization signal are transmitted in a same radio frame.

In one embodiment, a reception timing of the first synchronization signal determines a slot where the first synchronization signal is present; the second synchronization signal and the first synchronization signal are transmitted in a same slot.

In one embodiment, a reception timing of the first synchronization signal determines a radio frame where the first synchronization signal is present; the second synchronization signal and the first synchronization signal are transmitted in different radio frames.

In one embodiment, a reception timing of the first synchronization signal determines a slot where the first synchronization signal is present; the second synchronization signal and the first synchronization signal are transmitted in different slots.

In one embodiment, reception of the first synchronization signal is used to determine a timing reference radio frame i, the timing reference radio frame i being used to determine a start time of a sidelink radio frame i where the second synchronization signal is present, where a transmission timing of the second synchronization signal is the start time of the sidelink radio frame i where the second synchronization signal is present.

In one subembodiment, a reception timing of the first synchronization signal is a start time of a radio frame where the first synchronization signal is present.

In one subembodiment, the radio frame where the first synchronization signal is present is the timing reference radio frame i.

### Embodiment 10

Embodiment 10 illustrates a schematic diagram of a first sidelink MIB and a first identity being used to determine a sequence generating a second synchronization signal according to one embodiment of the present application, as shown in FIG. 10.

In one embodiment, the first identity is a sidelink synchronization signal identity.

In one embodiment, the first sidelink MIB indicates in coverage, and the first identity is determined as a sidelink synchronization signal identity of a sequence generating the second synchronization signal.

In one embodiment, the first sidelink MIB does not indicate in coverage, and the first identity belongs to a sidelink synchronization signal identity set out of coverage, the first identity being determined as a sidelink synchronization signal identity of a sequence generating the second synchronization signal.

In one subembodiment, the sidelink synchronization signal identity set out of coverage is a set identified by the i_oon.

In one subembodiment, sidelink synchronization signal identities comprised by the sidelink synchronization signal identity set out of coverage are integers from 336 to 671.

In one embodiment, the first sidelink MIB does not indicate in coverage, and the first identity does not belong to a sidelink synchronization signal identity set out of coverage, and the first synchronization signal uses a slot indicated by the second transmission timing information, and a sidelink synchronization signal identity of a sequence generating the second synchronization signal is 337.

In one subembodiment, the sidelink synchronization signal identity set out of coverage is a set identified by the i_oon.

In one subembodiment, sidelink synchronization signal identities comprised by the sidelink synchronization signal identity set out of coverage are integers from 336 to 671.

In one subembodiment, the first message indicates the second transmission timing information.

In one subembodiment, SidelinkPreconfigNR indicates the second transmission timing information.

In one subembodiment, the second transmission timing information is sl-SSB-TimeAllocation3.

In one embodiment, the first sidelink MIB does not indicate in coverage, and the first identity does not belong to a sidelink synchronization signal identity set out of coverage, and the first synchronization signal uses a slot indicated by timing information other than the second transmission timing information, and a sidelink synchronization signal identity of a sequence generating the second synchronization signal is a sum of the value of the first identity and 336.

In one subembodiment, the sidelink synchronization signal identity set out of coverage is a set identified by the i_oon.

In one subembodiment, sidelink synchronization signal identities comprised by the sidelink synchronization signal identity set out of coverage are integers from 336 to 671.

In one subembodiment, the first message indicates the second transmission timing information.

In one subembodiment, SidelinkPreconfigNR indicates the second transmission timing information.

In one subembodiment, the second transmission timing information is sl-SSB-TimeAllocation3.

### Embodiment 11

Embodiment 11 illustrates a schematic diagram of a first message being used to indicate transmission timing information of a second synchronization signal according to one embodiment of the present application, as shown in FIG. 11.

In one embodiment, the first message comprises sl-SSB-TimeAllocation1, the sl-SSB-TimeAllocation1 indicating transmission timing information of the second synchronization signal.

In one subembodiment, the sl-SSB-TimeAllocation1 indicates a number of sidelink SSBs transmitted within one period.

In one subembodiment, the sl-SSB-TimeAllocation1 indicates a slot offset of a start of a sidelink SSB period to a first sidelink SSB.

In one subembodiment, the sl-SSB-TimeAllocation1 indicates a slot interval of multiple adjacent sidelink SSBs.

In one subembodiment, the sidelink SSB comprises the second synchronization signal.

In one embodiment, the first message comprises sl-SSB-TimeAllocation2, the sl-SSB-TimeAllocation2 indicating transmission timing information of the second synchronization signal.

In one subembodiment, the sl-SSB-TimeAllocation2 indicates a number of sidelink SSBs transmitted within one period.

In one subembodiment, the sl-SSB-TimeAllocation2 indicates a slot offset of a start of a sidelink SSB period to a first sidelink SSB.

In one subembodiment, the sl-SSB-TimeAllocation2 indicates a slot interval of multiple adjacent sidelink SSBs.

In one subembodiment, the sidelink SSB comprises the second synchronization signal.

In one embodiment, the first message comprises sl-SSB-TimeAllocation3, the sl-SSB-TimeAllocation3 indicating transmission timing information of the second synchronization signal.

In one subembodiment, the sl-SSB-TimeAllocation3 indicates a number of sidelink SSBs transmitted within one period.

In one subembodiment, the sl-SSB-TimeAllocation3 indicates a slot offset of a start of a sidelink SSB period to a first sidelink SSB.

In one subembodiment, the sl-SSB-TimeAllocation3 indicates a slot interval of multiple adjacent sidelink SSBs.

In one subembodiment, the sidelink SSB comprises the second synchronization signal.

### Embodiment 12

Embodiment 12 illustrates a schematic diagram of second transmission timing information being used to determine a sidelink synchronization signal identity of a second synchronization signal according to one embodiment of the present application, as shown in FIG. 12.

In one embodiment, a sidelink synchronization signal identity of the second synchronization signal is a SLSS ID.

In one embodiment, a sidelink synchronization signal identity of the second synchronization signal is an SLSS ID.

In one embodiment, a sidelink synchronization signal identity of the second synchronization signal is N_{ID}^{SL}.

In one embodiment, a sidelink synchronization signal identity of the second synchronization signal includes a SLS SID.

In one embodiment, a sidelink synchronization signal identity of the second synchronization signal includes an SLSS ID.

In one embodiment, a sidelink synchronization signal identity of the second synchronization signal includes N_{ID}^{SL}.

In one embodiment, the first node receives a first sidelink MIB, the first sidelink MIB being transmitted along with the first synchronization signal.

In one embodiment, the first node receives a first sidelink MIB, the first sidelink MIB sharing a same transmitter with the first synchronization signal.

In one embodiment, a sidelink synchronization signal identity corresponding to the first synchronization signal is a first identity.

In one embodiment, the first sidelink MIB does not indicate in coverage, and the first identity does not belong to a sidelink synchronization signal identity set out of coverage, and the first synchronization signal uses a slot indicated by the second transmission timing information, and a sidelink synchronization signal identity of the second synchronization signal is 337.

In one subembodiment, the sidelink synchronization signal identity set out of coverage is a set identified by the i_oon.

In one subembodiment, sidelink synchronization signal identities comprised by the sidelink synchronization signal identity set out of coverage are integers from 336 to 671.

In one subembodiment, the first message indicates the second transmission timing information.

In one subembodiment, SidelinkPreconfigNR indicates the second transmission timing information.

In one subembodiment, the second transmission timing information is sl-SSB-TimeAllocation3.

In one embodiment, the first sidelink MIB does not indicate in coverage, and the first identity does not belong to a sidelink synchronization signal identity set out of coverage, and the first synchronization signal uses a slot indicated by timing information other than the second transmission timing information, and a sidelink synchronization signal identity of the second synchronization signal is a sum of a value of the first identity and 336.

In one subembodiment, the sidelink synchronization signal identity set out of coverage is a set identified by the i_oon.

In one subembodiment, sidelink synchronization signal identities comprised by the sidelink synchronization signal identity set out of coverage are integers from 336 to 671.

In one subembodiment, the first message indicates the second transmission timing information.

In one subembodiment, SidelinkPreconfigNR indicates the second transmission timing information.

In one subembodiment, the second transmission timing information is sl-SSB-TimeAllocation3.

### Embodiment 13

Embodiment 13 illustrates a schematic diagram of whether a first message comprises second transmission timing information being used to determine whether a second sidelink MIB indicates in coverage according to one embodiment of the present application, as shown in FIG. 13.

In one embodiment, the first message comprises the second transmission timing information, and the second sidelink MIB does not indicate in coverage; the first message does not comprise the second transmission timing information, and the second sidelink MIB indicates in coverage.

In one subembodiment, an inCoverage field in the second sidelink MIB being true indicates in coverage.

In one subembodiment, an inCoverage field in the second sidelink MIB being false does not indicate in coverage.

In one subembodiment, the second transmission timing information is sl-SSB-TimeAllocation3.

In one subembodiment, the first message comprises a SIB12.

In one subembodiment, the first message comprises a forwarded SIB12.

In one subembodiment, the first message comprises a RRCReconfiguration.

In one subembodiment, the first message is transmitted via a direct path.

In one subembodiment, the first message is not transmitted via a direct path.

In one embodiment, the first message comprises the second transmission timing information, and the second sidelink MIB indicates in coverage; the first message does not comprise the second transmission timing information, and the second sidelink MIB does not indicate in coverage.

In one subembodiment, an inCoverage field in the second sidelink MIB being true indicates in coverage.

In one subembodiment, an inCoverage field in the second sidelink MIB being false does not indicate in coverage.

In one subembodiment, the second transmission timing information is sl-SSB-TimeAllocation3.

In one subembodiment, the first message comprises a SIB12.

In one subembodiment, the first message comprises a forwarded SIB12.

In one subembodiment, the first message comprises a RRCReconfiguration.

In one subembodiment, the first message is transmitted via a direct path.

In one subembodiment, the first message is not transmitted via a direct path.

In one embodiment, the above method is advantageous in that determining whether a second sidelink MIB indicates in coverage according to whether second transmission timing information is comprised helps increase the flexibility.

### Embodiment 14

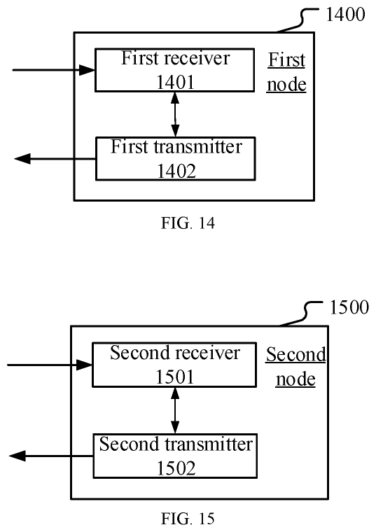

Embodiment 14 illustrates a structure block diagram of a processing device used in a first node according to one embodiment of the present application; as shown in FIG. 14. In FIG. 14, a first node processing device 1400 comprises a first receiver 1401 and a first transmitter 1402. In Embodiment 14,

the first receiver 1401 receives a first signal, the first signal comprising a first message; and determines a synchronization reference according to at least whether the first message is transmitted via a direct path; the first message indicating a first sidelink frequency list, the first sidelink frequency list comprising a first frequency, the first frequency being used for sidelink communication; and receiving a first synchronization signal from the synchronization reference determined; and

the first transmitter 1402 transmits a second synchronization signal; a reception timing for the first synchronization signal being used to determine a transmission timing of the second synchronization signal.

In one embodiment, the first receiver 1401 performs cell search to determine in coverage of at least a first cell;

herein, the first message is not transmitted via a direct path, and a synchronization priority order indicated by the first message is a base station, and the synchronization reference determined is a synchronization reference User Equipment (UE).

In one embodiment, the first receiver 1401 receives a first sidelink master information block (MIB), the first sidelink MIB indicating whether in coverage; a synchronization signal identity corresponding to the first synchronization signal is a first identity; the first sidelink MIB and the first identity are used to determine a sequence generating the second synchronization signal;

herein, the first message is used for indicating transmission timing information of the second synchronization signal, and a transmission timing of the second synchronization signal is different from a transmission timing of the first synchronization signal.

In one embodiment, the first receiver 1401 fails to detect a cell on a first frequency; the first message being not transmitted via a direct path; a transmitter of the first synchronization signal being determined as a synchronization reference; the synchronization reference determined being a synchronization reference UE; and a synchronization priority order indicated by the first message being a base station;

herein, the first message comprises first transmission timing information and second transmission timing information; the first transmission timing information is used to indicate transmission timing information of the second synchronization signal; the second transmission timing information is used to determine a sidelink synchronization signal identity of the second synchronization signal; and the second transmission timing information is related to Global Navigation Satellite System (GNSS).

In one embodiment, the first receiver 1401 performs cell search to determine not in coverage of a first cell but in coverage of a second cell; the first cell is a generator of the first message; and the first cell is a Primary Cell (PCell) or a serving cell of the first node 1400; the second cell is a cell other than the PCell or the serving cell of the first node 1400; the first cell and the second cell are both on the first frequency; the first frequency is a primary frequency;

herein, the first message is not transmitted via a direct path, and a synchronization priority order indicated by the first message is a base station, and the synchronization reference determined is the second cell.

In one embodiment, the first receiver 1401 performs cell search to determine in coverage of the first frequency; the first frequency is a frequency other than a primary frequency or a secondary frequency;

herein, the first message is not transmitted via a direct path, and the synchronization reference determined is the first frequency.

In one embodiment, the first transmitter 1402 transmits a second sidelink MIB; the second sidelink MIB being transmitted along with the second synchronization signal; whether the first message is transmitted via a direct path being used to determine whether the second sidelink MIB indicates in coverage;

herein, that whether the first message is transmitted via a direct path is used to determine whether the second sidelink MIB indicates in coverage comprises that:

when the first node 1400 is in coverage at the first frequency and the first message is not transmitted via a direct path, the second sidelink MIB does not indicate in coverage; when the first node 1400 is in coverage at the first frequency, and the first message is transmitted via a direct path, the second sidelink MIB indicates in coverage.

In one embodiment, the first transmitter 1402 transmits a second sidelink MIB; the second sidelink MIB being transmitted along with the second synchronization signal;

herein, GNSS is determined as a synchronization reference; the first message comprises second transmission timing information; and the second transmission timing information is used to indicate transmission timing information of the second synchronization signal; whether the first message comprises the second transmission timing information is used to determine whether the second sidelink MIB indicates in coverage.

In one embodiment, the first node is a UE.

In one embodiment, the first node is a terminal supporting large delay difference.

In one embodiment, the first node is a terminal supporting NTN.

In one embodiment, the first node is an aircraft.

In one embodiment, the first node is a vehicle-mounted terminal

In one embodiment, the first node is a relay.

In one embodiment, the first node is a vessel.

In one embodiment, the first node is an IoT terminal.

In one embodiment, the first node is an IIoT terminal.

In one embodiment, the first node is a piece of equipment supporting transmissions with low delay and high reliability.

In one embodiment, the first node is a sidelink communication node.

In one embodiment, the first receiver 1401 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1402 comprises at least one of the antenna 452, the transmitter 454, the transmitting processor 468, the multi-antenna transmitting processor 457, the controller/processor 459, the memory 460 or the data source 467 in Embodiment 4.

### Embodiment 15

Embodiment 15 illustrates a structure block diagram of a processing device used in a second node according to one embodiment of the present application; as shown in FIG. 15. In FIG. 15, a second node processing device 1500 comprises a second transmitter 1502 and a second receiver 1501. In Embodiment 15,

the second receiver 1501 receives a second signal, the second signal comprising a first message; the first message indicating a first sidelink frequency list, the first sidelink frequency list comprising a first frequency, the first frequency being used for sidelink communication;

the second transmitter 1502 transmits a first signal and a first synchronization signal, the first signal comprising the first message; a receiver of the first signal, determining a synchronization reference according to at least whether the first message is transmitted via a direct path;

a receiver of the first signal, transmitting a second synchronization signal; a reception timing of the first synchronization signal is used to determine a transmission timing of the second synchronization signal.

In one embodiment, the second transmitter 1502 transmits a first sidelink master information block (MIB), the first sidelink MIB indicating whether in coverage; a synchronization signal identity corresponding to the first synchronization signal is a first identity; the first sidelink MIB and the first identity are used to determine a sequence generating the second synchronization signal;

herein, the first message is used for indicating transmission timing information of the second synchronization signal, and a transmission timing of the second synchronization signal is different from a transmission timing of the first synchronization signal.

In one embodiment, the second receiver 1501 receives a second synchronization signal and a second sidelink MIB, the second node 1500 providing relay service to a transmitter of the second synchronization signal and the second sidelink MIB; when a first condition set is satisfied, the transmitter of the second synchronization signal and the second sidelink MIB is not determined as a synchronization reference; a synchronization priority order indicated by the first message is a base station.

In one embodiment, the second node is a satellite.

In one embodiment, the second node is a UE.

In one embodiment, the second node is an IoT node.

In one embodiment, the second node is a wearable node.

In one embodiment, the second node is a relay.

In one embodiment, the second node is an access point.

In one embodiment, the second node is a sidelink communication node.

In one embodiment, the second transmitter 1502 comprises at least one of the antenna 420, the transmitter 418, the transmitting processor 416, the multi-antenna transmitting processor 471, the controller/processor 475 or the memory 476 in Embodiment 4.

In one embodiment, the second receiver 1501 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, which receives a first signal, the first signal comprising a first message; and determines a synchronization reference according to at least whether the first message is transmitted via a direct path; the first message indicating a first sidelink frequency list, the first sidelink frequency list comprising a first frequency, the first frequency being used for sidelink communication; and receives a first synchronization signal from the synchronization reference determined; and
a first transmitter, which transmits a second synchronization signal; a reception timing for the first synchronization signal being used to determine a transmission timing of the second synchronization signal.

2. The first node according to claim 1, characterized in comprising:
the first receiver, which performs cell search to determine in coverage of at least a first cell;
wherein the first message is not transmitted via a direct path, and a synchronization priority order indicated by the first message is a base station, and the synchronization reference determined is a synchronization reference User Equipment (UE).

3. The first node according to claim 1, characterized in comprising:
the first receiver, which receives a first sidelink master information block (MIB), the first sidelink MIB indicating whether in coverage; a synchronization signal identity corresponding to the first synchronization signal is a first identity; the first sidelink MIB and the first identity are used to determine a sequence generating the second synchronization signal;
wherein the first message is used for indicating transmission timing information of the second synchronization signal, and a transmission timing of the second synchronization signal is different from a transmission timing of the first synchronization signal.

4. The first node according to claim 2, characterized in comprising:
the first receiver, which receives a first sidelink master information block (MIB), the first sidelink MIB indicating whether in coverage; a synchronization signal identity corresponding to the first synchronization signal is a first identity; the first sidelink MIB and the first identity are used to determine a sequence generating the second synchronization signal;
wherein the first message is used for indicating transmission timing information of the second synchronization signal, and a transmission timing of the second synchronization signal is different from a transmission timing of the first synchronization signal.

5. The first node according to claim 1, characterized in comprising:
the first receiver, which fails to detect a cell on a first frequency; the first message being not transmitted via a direct path; a transmitter of the first synchronization signal being determined as a synchronization reference; the synchronization reference determined being a synchronization reference UE; and a synchronization priority order indicated by the first message being a base station;
wherein the first message comprises first transmission timing information and second transmission timing information; the first transmission timing information is used to indicate transmission timing information of the second synchronization signal; the second transmission timing information is used to determine a sidelink synchronization signal identity of the second synchronization signal; and the second transmission timing information is related to Global Navigation Satellite System (GNSS).

6. The first node according to claim 1, characterized in comprising:
the first receiver, which performs cell search to determine not in coverage of a first cell but in coverage of a second cell; the first cell is a generator of the first message; and the first cell is a Primary Cell (PCell) or a serving cell of the first node; the second cell is a cell other than the PCell or the serving cell of the first node; the first cell and the second cell are both in the first frequency; the first frequency is a primary frequency;
wherein the first message is not transmitted via a direct path, and a synchronization priority order indicated by the first message is a base station, and the synchronization reference determined is the second cell.

7. The first node according to claim 1, characterized in comprising:
the first receiver, which performs cell search to determine in coverage of the first frequency; the first frequency is a frequency other than a primary frequency or a secondary frequency;
wherein the first message is not transmitted via a direct path, and the synchronization reference determined is the first frequency.

8. The first node according to claim 1, characterized in comprising:
the first transmitter, which transmits a second sidelink MIB; the second sidelink MIB being transmitted along with the second synchronization signal; whether the first message is transmitted via a direct path being used to determine whether the second sidelink MIB indicates in coverage;
wherein that whether the first message is transmitted via a direct path is used to determine whether the second sidelink MIB indicates in coverage comprises that:
when the first node is in coverage in the first frequency and the first message is not transmitted via a direct path, the second sidelink MIB does not indicate in coverage; when the first node is in coverage in the first frequency, and the first message is transmitted via a direct path, the second sidelink MIB indicates in coverage.

9. The first node according to claim 1, characterized in comprising:
the first transmitter, which transmits a second sidelink MIB; the second sidelink MIB being transmitted along with the second synchronization signal;
wherein GNSS is determined as a synchronization reference; the first message comprises second transmission timing information; and the second transmission timing information is used to indicate transmission timing information of the second synchronization signal; whether the first message comprises the second transmission timing information is used to determine whether the second sidelink MIB indicates in coverage.

10. The first node according to claim 1, characterized in that the first node is in RRC CONNECTED state.

11. The first node according to claim 1, characterized in that the first message is a System Information Block 12 (SIB12); the first signal is transmitted via a sidelink; being not transmitted via a direct path includes being transmitted via relay.

12. The first node according to claim 1, characterized in that the first synchronization signal and the second synchronization signal are in a same frequency.

13. The first node according to claim 1, characterized in that the first synchronization signal and the second synchronization signal are in different frequencies.

14. The first node according to claim 1, characterized in that
the second synchronization signal is used to indicate a type of the synchronization reference; when a sidelink synchronization signal identity corresponding to the second synchronization signal is equal to 0, it is indicated that the type of the synchronization reference is GNSS; when a sidelink synchronization signal identity corresponding to the second synchronization signal is unequal to 0, it is indicated that the type of the synchronization reference is not GNSS.

15. The first node according to claim 1, characterized in that
a transmission time of the second synchronization signal is equal to a sum of a reception time of the first synchronization signal and a first time offset, where the first time offset is a non-zero real number; the first time offset is indicated by the first message.

16. The first node according to claim 2, characterized in that
the first message is a SIB12; the first signal is transmitted via a sidelink; being not transmitted via a direct path includes being transmitted via relay.

17. The first node according to claim 5, characterized in that
the first message is a SIB12; the first signal is transmitted via a sidelink; being not transmitted via a direct path includes being transmitted via relay.

18. The first node according to claim 6, characterized in that
the first message is a SIB12; the first signal is transmitted via a sidelink; being not transmitted via a direct path includes being transmitted via relay.

19. The first node according to claim 7, characterized in that
the first message is a SIB12; the first signal is transmitted via a sidelink; being not transmitted via a direct path includes being transmitted via relay.

20. A method in a first node for wireless communications, comprising:
receiving a first signal, the first signal comprising a first message; and determining a synchronization reference according to at least whether the first message is transmitted via a direct path; the first message indicating a first sidelink frequency list, the first sidelink frequency list comprising a first frequency, the first frequency being used for sidelink communication; and receiving a first synchronization signal from the synchronization reference determined; and
transmitting a second synchronization signal; a reception timing for the first synchronization signal being used to determine a transmission timing of the second synchronization signal.
